(19) United States
(12) Patent Application Publication
(10) Pub. No.: US 2016/0155412 A1
(43) Pub. Date: Jun. 2, 2016

(54) ELECTRONIC APPARATUS AND METHOD OF CONTROLLING ELECTRONIC APPARATUS

(71) Applicant: SEIKO EPSON CORPORATION, Tokyo (JP)

(72) Inventors: Fusashi KIMURA, Matsumoto-shi (JP); Kazuo NISHIZAWA, Matsumoto-shi (JP)

(21) Appl. No.: 14/941,169

(22) Filed: Nov. 13, 2015

(30) Foreign Application Priority Data
Nov. 28, 2014 (JP) 2014-241189
Jun. 19, 2015 (JP) 2015-123465

(51) Int. Cl. G09G 5/00; G06F 9/44; G06F 3/03

(52) U.S. Cl. CPC G09G 5/006; G06F 3/03; G06F 9/44; G09G 2354/00

(57) ABSTRACT

A control device is a device which is connected to a head-mounted image display unit and controls the display of the image display unit. The control device includes a key operation unit which receives an operation, and a control unit which executes a general-purpose OS and an application program operating on the OS. The OS has a control function which is executed when an operating unit receives a predetermined operation, and includes a key code API which is callable by the application program and limits the execution of the control function.

### BACKGROUND

1. Technical Field

The present invention relates to an electronic apparatus and a method of controlling an electronic apparatus.

2. Related Art

In recent years, various means for operating a head-mounted display device have been suggested (see JP-T-2014-503085). A device described in JP-T-2014-503085 operates corresponding to a speech input, or an input, such as motion of a hand detected by a camera or motion of a head of a user.

As described in JP-T-2014-503085, functions which are executed corresponding to inputs include functions which are executed by an operating system of a device and functions which are executed by an application program. Usually, since the application program uses a service provided by the operating system, when the operating system executes a function corresponding to an input, the application program has not executed different functions corresponding to the same input. For this reason, there is no example where the application program implements operation deviated from the specification of the operating system.

### SUMMARY

An advantage of some aspects of the invention is to implement functions of an application program by controlling a display device without being limited by the specification of an operating system.

An aspect of the invention is directed to an electronic apparatus which is connected to a head-mounted display device and controls the display of the display device, the electronic apparatus including: an operating unit which receives an operation; and a control unit which executes a general-purpose operating system and an application program operating on the operating system, in which the operating system has a control function which is executed when the operating unit receives a predetermined operation, and includes a program module which is callable by the function of the application program and limits the execution of the control function.

According to the aspect of the invention, operation which is executed by the operating system when a predetermined operation is received can be limited by the function of the application program. For this reason, it is possible to relax a restriction to the specification of the operating system in terms of the function of the application program.

In the electronic apparatus according to the aspect of the invention, the apparatus may include: a display control unit which controls the display device to display an image, in which the control unit may allow the display control unit to display a screen for the operating system during the execution of the application program by the control function.

According to the aspect of the invention with this configuration, a function of displaying a screen for an operating system corresponding to a predetermined operation can be limited by the application program. With this, it is possible to avoid a situation in which the screen for an operating system is displayed during the execution of the application program, and to allow the application program to control the display content of the head-mounted display device.

In the electronic apparatus according to the aspect of the invention, the control unit may allow the display of an initial screen of the operating system by the control function.

According to the aspect of the invention with this configuration, it is possible to allow the application program to limit a function of displaying the initial screen of the operating system corresponding to a predetermined operation.

In the electronic apparatus according to the aspect of the invention, the initial screen may be a screen which is displayed by the display control unit before the application program is executed after the activation of the operating system.

According to the aspect of the invention with this configuration, it is possible to allow the application program to limit a function of displaying the initial screen of the operating system displayed before the execution of the application program corresponding to a predetermined operation. With this, it is possible to allow the application program to perform control such that the display content does not return to a screen before the execution of the application program during the execution of the application program.

In the electronic apparatus according to the aspect of the invention, the operating unit may include an operation region or an operator for the control function.

According to the aspect of the invention with this configuration, it is possible to limit a function executed by the operating system corresponding to an operation of a specific operation region or an operator by the function of the application program.

In the electronic apparatus according to the aspect of the invention, the control unit may execute the control function when the operating unit receives a predetermined operation after the application program is stopped during the execution of the operating system.

According to the aspect of the invention with this configuration, it is possible to release the limitation of the function of the operating system by stopping the application program.

In the electronic apparatus according to the aspect of the invention, the operating unit may be configured to receive a plurality of operations, and the control unit may be capable of executing a plurality of control functions corresponding to an operation of the operating unit and may limit the execution of at least one of the plurality of control functions at the time of the execution of the program module.

According to the aspect of the invention with this configuration, it is possible to limit part or all of the functions by the function of the application program in a configuration in which the operating system can execute a plurality of functions corresponding to a plurality of operations.

Another aspect of the invention is directed to an electronic apparatus which is connected to a head-mounted display device and controls the display of the display device, the electronic apparatus including: a control unit which executes a general-purpose operating system and an application program operating on the operating system, in which the control unit recognizes a first operation, a second operation, and a third operation and executes processing corresponding to a recognized operation, and the control unit is capable of transiting, corresponding to the first operation, to a full limit state where the second and third operations are disabled, an individual limit state where at least one of the second and third operations is disabled during the execution of the application program, and a limit release state where the second and third operations are respectively recognized.

According to the aspect of the invention, it is possible to release the restriction to the specification of the operating system and to appropriately set the correspondence to operations at the time of the execution of the application program.

In the electronic apparatus according to the aspect of the invention, the electronic apparatus may includes: a storage unit which stores disable setting data for setting an operation to disable the individual limited state, in which the control unit may disable at least one of the second and third operations according to the disable setting data stored in the storage unit in the individual limit state.

According to the aspect of the invention with this configuration, it is possible to set a state where an operation is disabled by the disable setting data.

In the electronic apparatus according to the aspect of the invention, the control unit may transit to the limit release state when the first operation is recognized in the full limit state or the individual limit state.

According to the aspect of the invention with this configuration, it is possible to quickly release a state where an operation is disabled.

In the electronic apparatus according to the aspect of the invention, the control unit may transit to a preset state out of the full limit state and the individual limit state when the first operation is recognized after having transited from the full limit state or the individual limit state to the limit release state.

According to the aspect of the invention with this configuration, it is possible to set a state when the limitation is released from a state where an operation is disabled according to the specification of the application program or the like.

In the electronic apparatus according to the aspect of the invention, the control unit may transit to a state where the operating system displays a predetermined home screen and the second and third operations are recognizable after the execution of the application program ends.

According to the aspect of the invention with this configuration, when the execution of the application program ends, a function to an operation is executable by the operating system.

In the electronic apparatus according to the aspect of the invention, the storage unit may store home setting data for setting a function executed by the control unit corresponding to an operation recognized in a state where the home screen is displayed, and the control unit may execute a function set by the home setting data when the first operation is recognized in a state where the home screen is displayed.

According to the aspect of the invention with this configuration, when the execution of the application program ends, it is possible to set a function executed corresponding to an operation.

In the electronic apparatus according to the aspect of the invention, the control unit may execute a function set by the home setting data when one of the second and third operations is recognized in a state where the home screen is displayed.

According to the aspect of the invention with this configuration, when the execution of the application program ends, it is possible to set a function corresponding to an operation.

In the electronic apparatus according to the aspect of the invention, a function which may be executed when the control unit recognizes one of the first, second and third operations in a state where the home screen is displayed is set by default, and the control unit may execute a function selected in advance out of a function set by the home setting data and the function set by default when one of the first, second and third operations is recognized in a state where the home screen is displayed.

According to the aspect of the invention with this configuration, when the execution of the application program ends, it is possible to select a function executed corresponding to an operation from a default function and a set function.

In the electronic apparatus according to the aspect of the invention, the electronic apparatus may include: an operating unit which has a first operator, a second operator and a third operator, in which the control unit may recognize the first operation when the first operator is operated, recognize the second operation when the second operator is operated, and recognize the third operation when the third operator is operated.

According to the aspect of the invention with this configuration, it is possible to easily switch the limitation to operations of the second and third operators corresponding to an operation of the first operator.

Here, the first operator, the second operator and the third operator in the operating unit may be operators with a movable portion, or an operator with no movable portion, such as a touch pad which detects a touch operation, or may have a configuration in which an operation is detected in a noncontact manner.

In the electronic apparatus according to the aspect of the invention, the apparatus may include: an operating unit which has an operator capable of performing an operation corresponding to each of the second operation and the third operation, and the control unit may recognize each of the first and second operations to the operator.

According to the aspect of the invention with this configuration, it is possible to individually limit different kinds of operations on one operator.

Here, an operator in the operating unit may be an operator with a movable portion, may be an operator with no movable portion, such as a touch pad which detects a touch operation, or may have a configuration in which an operation is detected in a noncontact manner.

Still another aspect of the invention is directed to a method of controlling an electronic apparatus which is connected to a head-mounted display device and controls the display of the display device, the method including: executing a general-purpose operating system and an application program operating on the operating system; executing a predetermined control function by the operating system when an operating unit receives a predetermined operation; and controlling the execution of the predetermined control function when a predetermined program module is called by the function of the application program.

According to the aspect of the invention, it is possible to limit operation executed by the operating system when a predetermined operation is received by the function of the application program. For this reason, it is possible to relax the restriction to the specification of the operating system in terms of the function of the application program.

Yet another aspect of the invention is directed to a method of controlling an electronic apparatus which is connected to a head-mounted display device, recognizes a first operation, a second operation, and a third operation, and controls the display device corresponding to a recognized operation, the method including: executing a general-purpose operating system and an application program operating on the operating system; and corresponding to the first operation, transiting to a full limit state where the second operation and the third operation are disabled, an individual limit state where at least one of the second and third operations is disabled during the execution of the application program, and a limit release state where the second and third operations are respectively recognized.

According to the aspect of the invention, it is possible to relax the restriction to the specification of the operating system, and to set the correspondence to operations at the time of the execution of the application program.

The invention can also be implemented as a program or a program module which is executable when a computer which is connected to a head-mounted display device and controls the display of the display device executes a general-purpose operating system and an application program operating on the operating system. The program causes the computer to function as a control unit which recognizes a first operation, a second operation, and a third operation and executes processing corresponding to a recognized operation. The control unit is capable of transiting, corresponding to the first operation, to a full limit state where the second and third operations are disabled, an individual limit state where at least one of the second and third operations is disabled during the execution of the application program, and a limit release state where the second and third operations are respectively recognized.

According to the aspect of the invention, it is possible to relax the restriction to the specification of the operating system, and to set the correspondence to operations at the time of the execution of the application program.

The invention can also be implemented as a recording medium having the program recorded thereon.

### BRIEF DESCRIPTION OF THE DRAWINGS

The invention will be described with reference to the accompanying drawings, wherein like numbers reference like elements.

FIG. 1 is an explanatory view showing the appearance configuration of a head-mounted display device in a first embodiment.

FIG. 2 is a functional block diagram of each unit constituting the head-mounted display device.

FIG. 3 is a diagram showing a setting example of a key code.

FIG. 4 is a flowchart showing the operation of the head-mounted display device of the first embodiment.

FIG. 5 is a functional block diagram of each unit constituting a head-mounted display device of a second embodiment.

FIG. 6 is an appearance diagram of a control device of the second embodiment.

FIGS. 7a and 7b are a diagram showing an example of setting relating to a key code and a lock state of the second embodiment.

FIG. 8 is an explanatory view showing transition of an operation state of the head-mounted display device of the second embodiment.

FIG. 9 is a flowchart showing the operation of the head-mounted display device of the second embodiment.

FIG. 10 is a flowchart showing the operation of the head-mounted display device of the second embodiment.

### DESCRIPTION OF EXEMPLARY EMBODIMENTS

### First Embodiment

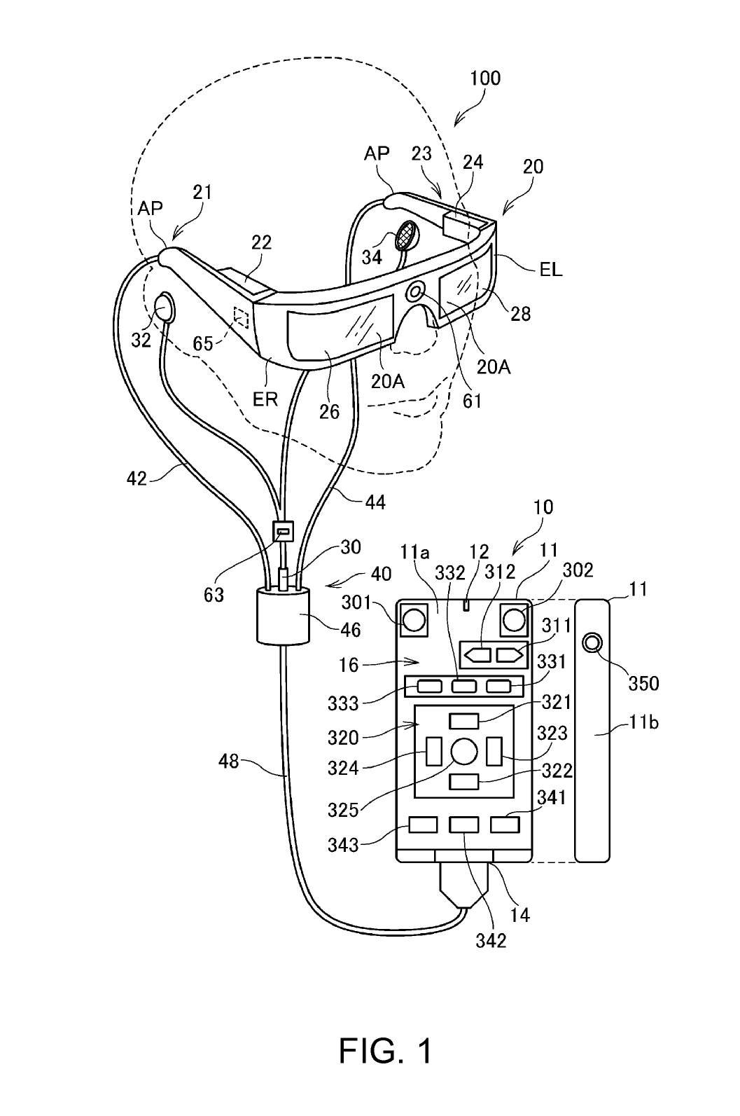

FIG. 1 is an explanatory view showing the appearance configuration of a head-mounted display device 100 according to a first embodiment to which the invention is applied.

The head-mounted display device 100 includes an image display unit 20 (display device) which allows a user to visually recognize a virtual image in a state mounted on the head of the user, and a control device 10 (electronic apparatus) which controls the image display unit 20. The control device 10 functions as a controller which is used when the user operates the head-mounted display device 100. FIG. 1 shows a side view of the control device 10 along with the front surface of the control device 10.

The image display unit 20 is a mounting body which is mounted on the head of the user, and in this embodiment, has an eyeglass shape. The image display unit 20 includes a right holding unit 21, a right display drive unit 22, a left holding unit 23, a left display drive unit 24, a right optical image display unit 26, a left optical image display unit 28, a camera 61, and a microphone 63. The right optical image display unit 26 and the left optical image display unit 28 are respectively positioned in front of the right and left eyes of the user when the user mounts the image display unit 20. One end of the right optical image display unit 26 and one end of the left optical image display unit 28 are connected to each other at a position corresponding to the brow of the user when the user mounts the image display unit 20.

The right holding unit 21 is a member which extends from an end portion ER, which is the other end of the right optical image display unit 26, to a position corresponding to the temporal portion of the user when the user mounts the image display unit 20. Similarly, the left holding unit 23 is a member which extends from an end portion EL, which is the other end of the left optical image display unit 28, to a position corresponding to the temporal portion of the user when the user mounts the image display unit 20. The right holding unit 21 and the left holding unit 23 hold the image display unit 20 on the head of the user, like the temple of the eyeglasses.

The right display drive unit 22 and the left display drive unit 24 are disposed on the side opposed to the head of the user when the user mounts image display unit 20. The right display drive unit 22 and the left display drive unit 24 are collectively referred to as a “display drive unit, and the right optical image display unit 26 and the left optical image display unit 28 are collectively referred to as an “optical image display unit”.

The display drive units 22 and 24 respectively include liquid crystal displays 241 and 242 (hereinafter, referred to as “LCDs 241 and 242”), projection optical systems 251 and 252, and the like.

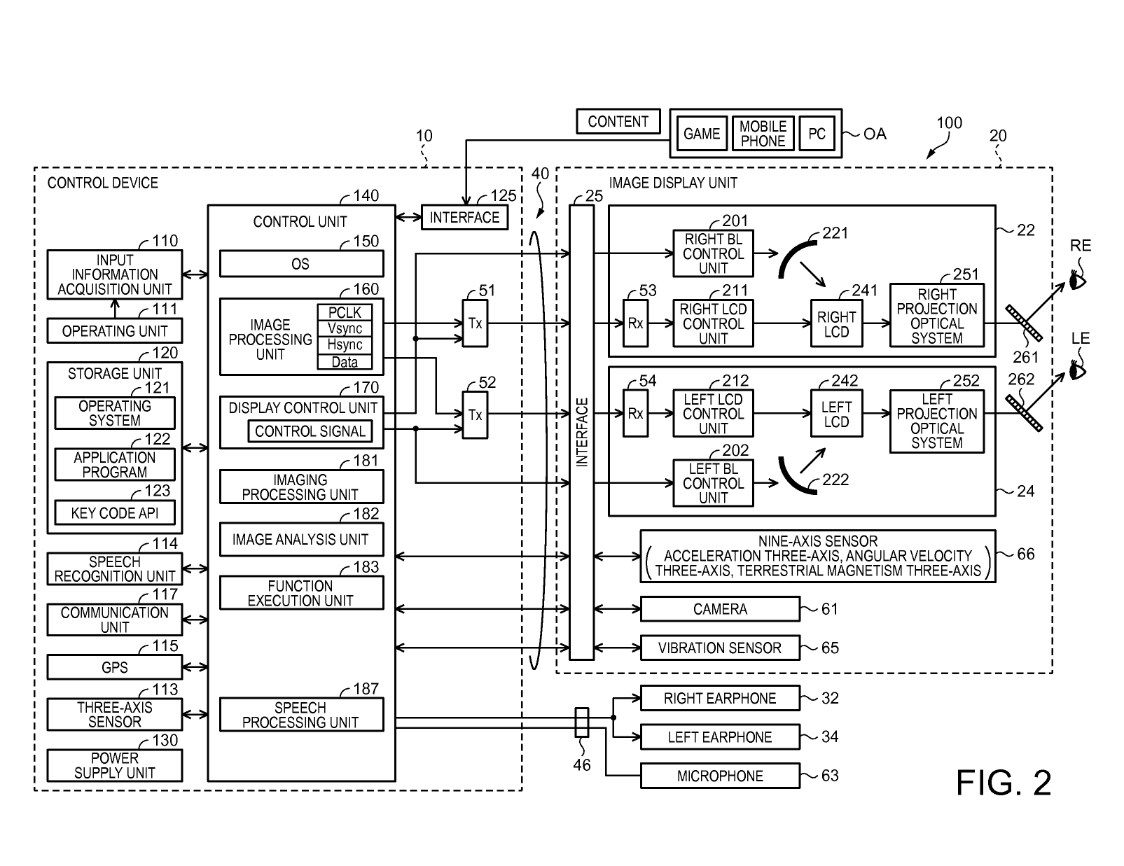

The right optical image display unit 26 and the left optical image display unit 28 respectively include light guide plates 261 and 262 (FIG. 2), and dimmer plates 20A. The light guide plates 261 and 262 are formed of transmissive resin or the like, and guide image light output from the display drive units 22 and 24 to the user's eyes. The dimmer plates 20A are thin plate-shaped optical elements and are disposed so as to cover the front side of the image display unit 20 which is the side opposite to the user's eyes side. For the dimmer plates 20A, various dimmer plates, such as a dimmer plate substantially having no light transmission, a dimmer plate which is substantially transparent, a dimmer plate which attenuates the amount of light and transmits light, and a dimmer plate which attenuates or reflects light having a specific wavelength, can be used. It is possible to adjust the amount of external light entering the right optical image display unit 26 and the left optical image display unit 28 from the outside to adjust ease of visual recognition of a virtual image by appropriately selecting the optical characteristics (transmittance and the like) of the dimmer plates 20A. In this embodiment, a case where at least the dimmer plates 20A having such light transmission that the user who mounts the head-mounted display device 100 can visually recognize an outside scene are used will be described. The dimmer plates 20A protect the right light guide plate 261 and the left light guide plate 262, and suppress damage, stain adhesion, or the like to the right light guide plate 261 and the left light guide plate 262.

The dimmer plate 20A may be detachably provided with respect to the right optical image display unit 26 and the left optical image display unit 28, may be mounted by replacing a plurality of kinds of dimmer plates 20A, or may be omitted.

The head-mounted display device 100 allows image light of an image to be processed therein and external light to enter the user's eyes in an overlapping manner, an outside scene is visible to the user through the dimmer plates 20A, and the image by image light is visually recognized to overlap the outside scene. In this way, the head-mounted display device 100 functions as a see-through display device.

The camera 61 is disposed in the boundary portion between the right optical image display unit 26 and the left optical image display unit 28. In a state where the user mounts the image display unit 20, the position of the camera 61 is substantially intermediate between both eyes of the user in a horizontal direction, and is above both eyes of the user in a vertical direction. The camera 61 is a digital camera which includes an imaging element, such as a CCD or a CMOS, an imaging lens, and the like, and may be a monocular camera or a stereo camera.

The camera 61 images an outside scene in a front-side direction of the head-mounted display device 100, in other words, at least a part of a visual field direction of the user in a state of mounting the head-mounted display device 100. Although the width of the image angle of the camera 61 can be appropriately set, it is desirable that the imaging range of the camera 61 is a range which includes an outside world which is visually recognized by the user through the right optical image display unit 26 and the left optical image display unit 28. Furthermore, it is desirable that the imaging range of the camera 61 is set so as to image the entire visual field of the user through the dimmer plate 20A.

The camera 61 executes imaging under the control of a control unit 140 (FIG. 2) and outputs captured image data to the control unit 140.

The image display unit 20 is connected to the control device 10 through a connection unit 40. The connection unit 40 includes a body cord 48 which is connected to the control device 10, a right cord 42, a left cord 44, and a connection member 46. The right cord 42 and the left cord 44 are cords which are two parts branched from the body cord 48. The right cord 42 is inserted into the housing of the right holding unit 21 from a tip portion AP in the extension direction of the right holding unit 21 and is connected to the right display drive unit 22. Similarly, the left cord 44 is inserted into the housing of the left holding unit 23 from a tip portion AP in the extension direction of the left holding unit 23 and is connected to the left display drive unit 24.

The connection member 46 is provided at a branch point of the body cord 48 and the right and left cords 42 and 44, and has a jack for connection to an earphone plug 30. A right earphone 32 and a left earphone 34 extend from the earphone plug 30. A microphone 63 is provided near the earphone plug 30. The cords are put together in a single cord from the earphone plug 30 to the microphone 63, are branched from the microphone 63 and are respectively connected to the right earphone 32 and the left earphone 34.

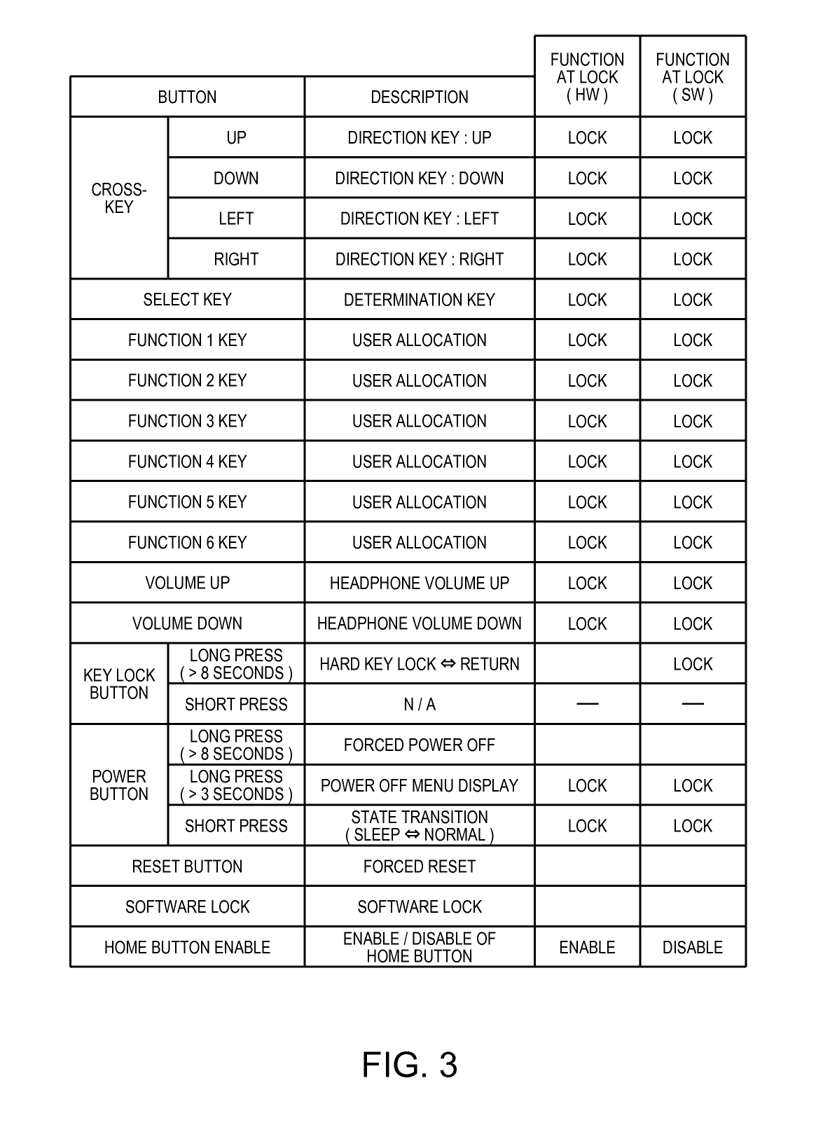

For example, as shown in FIG. 1, the microphone 63 is disposed such that a sound pickup unit of the microphone 63 turns toward the visual line direction of the user. The microphone 63 picks up speech and outputs a speech signal to a speech processing unit 187 (FIG. 3). The microphone 63 may be, for example, a monaural microphone or a stereo microphone, or may be a directional microphone or a non-directional microphone.

The right cord 42, the left cord 44, and the body cord 48 may be cords which can transmit digital data, and may be constituted of, for example, a metal cable or an optical fiber. The right cord 42 and the left cord 44 may be put together in a single cord.

The image display unit 20 and the control device 10 transmit various signals through the connection unit 40. An end portion of the body cord 48 opposite to the connection member 46 and the control device 10 are provided with connectors (not shown) which are fitted to each other. The control device and the image display unit 20 can be connected or disconnected by fitting or releasing the fitting of the connector of the body cord 48 and the connector of the control device 10.

The control device 10 controls the head-mounted display device 100. The control device 10 has a substantially box-like control device main body 11, and stores the respective units including the control unit 140 (FIG. 2) in the control device main body 11. A connector 14 to which the body cord 48 is connected is provided in a base end portion of the control device main body 11.

A key operation unit 16 (operating unit) having a plurality of key switches is provided in an upper surface 11a of the control device main body 11. The key operation unit 16 has a power button 301 which switches the power on and off of the head-mounted display device 100, and a lock button 302 which switches lock/lock release of part of operations of the key operation unit 16. The power button 301 and the lock button 302 are operators relating to the basic operation of the control device 10.

The key operation unit 16 has a volume up key 311 and a volume down key 312 for volume adjustment, three function keys 331, 332, and 333 to which functions are allocable, and a direction key unit 320. The direction key unit 320 includes four direction keys 321, 322, 323, and 324 corresponding to up, down, right, and left, and a determination key 325 disposed at the center. These are operators which are primarily used by the user during the execution of an operating system (OS) 150 or an application program described below.

On a base end portion side of the key operation unit 16, a menu button 341, a home button 342, and a “return” button 343 are arranged side by side. The menu button 341, the home button 342, and the “return” button 343 are operators for executing the basic functions of the OS 150.

In a side surface 11b of the control device main body 11, a reset button 350 is disposed. The reset button 350 is an operator for resetting the operation of the head-mounted display device 100. If the reset button 350 is operated, processing being executed by the control device 10 is forcibly stopped, and the control device 10 returns to an initial state. During this time, the image display unit 20 which is controlled by the control device 10 is initialized.

Each operator in the key operation unit 16 may be constituted as a hardware switch, such as a tactile switch or a push button switch. Furthermore, each operator may be constituted of a touch type switch in which a detection unit (not shown) configured to detect a touch operation and a display unit (not show) configured to display the position of the operator are combined. Here, it is desirable that the reset button 350 is a hardware switch in order to prevent an erroneous operation. For example, a configuration can be made in which a hole is provided in the side surface 11b and the reset button 350 constituted of a tactile switch is disposed at the bottom of the hole so as to be operable only by a pin or the like passing through the hole of the side surface 11b.

The control device 10 has a lighting unit 12. The lighting unit 12 includes a light source, such as a light emitting diode (LED), and notifies the operation state (for example, power on/off) of the head-mounted display device 100 by the lighting state of a light source.

FIG. 2 is a functional block diagram of each unit constituting the head-mounted display device 100.

The head-mounted display device 100 includes an interface 125 which connects various external apparatuses OA as a supply source of content. For the interface 125, for example, an interface corresponding to wired connection, such as a USB interface, a micro USB interface, or an interface for a memory card, can be used. The interface 125 may be constituted of a wireless communication interface. The external apparatus OA is an image supply device which supplies an image to the head-mounted display device 100, and a personal computer (PC), a mobile phone terminal, a mobile game machine, or the like is used.

The control device 10 has a control unit 140, an input information acquisition unit 110, a storage unit 120, a transmission unit (Tx) 51, and a transmission unit (Tx) 52.

The input information acquisition unit 110 is connected to the operating unit 111. The operating unit 111 is connected to each operator of the key operation unit 16 in the control device 10. The operating unit 111 detects an operation of each operator and outputs an operation signal corresponding to the detected operator to the input information acquisition unit 110. The input information acquisition unit 110 acquires an input content input by the operation of the control device 10 based on a signal input from the operating unit 111.

The storage unit 120 is a nonvolatile storage device, and stores various computer programs and data relating to the programs. Furthermore, the storage unit 120 may store data of still image or moving image displayed on the image display unit 20.

The control device 10 includes a power supply unit 130 which has a primary batter or a secondary battery, and supplies power from the power supply unit 130 to the respective units of the control device 10 and the image display unit 20.

A three-axis sensor 113, a speech recognition unit 114, a GPS 115, and a communication unit 117 are connected to the control unit 140. The three-axis sensor 113 is a three-axis acceleration sensor, and the control unit 140 acquires a detection value of the three-axis sensor 113. The GPS 115 includes an antenna (not shown). The GPS 115 receives a global positioning system (GPS) signal and calculates the current position of the control device 10. The GPS 115 outputs the current position obtained based on the GPS signal or the current time to the control unit 140. Furthermore, the GPS 115 may include a function of acquiring the current time based on information included in the GPS signal and correcting the time measured by the control unit 140.

The communication unit 117 executes wireless data communication based on a standard, such as wireless LAN (WiFi (Registered Trademark)), Miracast (Registered Trademark), or Bluetooth (Registered Trademark).

When the external apparatus OA is connected to the communication unit 117 in a wireless manner, the control unit 140 acquires content data by the communication unit 117 and allows the image display unit 20 to display an image. When the external apparatus OA is connected to the interface 125 in a wired manner, the control unit 140 acquires content data from the interface 125 and allows the image display unit 20 to display an image. The communication unit 117 and the interface 125 function as a data acquisition unit DA which acquires content data from the external apparatus OA.

The control unit 140 includes a CPU (not shown) which executes a program, a RAM (not shown) which temporarily stores the program executed by the CPU or data, and a ROM (not shown) which stores a basic control program executed by the CPU or data in a nonvolatile manner.

The control unit 140 reads and executes a computer program stored in the storage unit 120 to function as an OS 150, an image processing unit 160, a display control unit 170, an imaging processing unit 181, an image analysis unit 182, a function execution unit 183, and a speech processing unit 187.

The storage unit 120 stores an operating system 121, an application program 122, and a key code API 123.

The operating system 121 includes an execution file of the program executed by the CPU of the control unit 140, data processed by the program, and the like. The operating system 121 is constituted of, for example, a file group including a plurality of files, such as the execution file and data for screen display. The CPU of the control unit 140 reads the operating system 121 from the storage unit 120 and executes the operating system 121 to implement the function of the OS 150. The operating system 121 is a general-purpose operating system. As this kind of operating system, for example, Windows (Registered Trademark), iOS (Registered Trademark), Android (Registered Trademark), Mac OS (Registered Trademark), Linux (Registered Trademark), Unix (Registered Trademark), Tron (Registered Trademark), and the like are known. The general-purpose operating systems may be partially modified for use in the head-mounted display device 100.

The application program 122 includes the execution file of the program executed by the CPU of the control unit 140, data processed by the program, and the like. For example, the application program 122 is constituted of a file group including a plurality of files, such as the execution file and data for screen display. The CPU of the control unit 140 reads the application program 122 from the storage unit 120 and executes the application program 122, whereby the imaging processing unit 181, the image analysis unit 182, the function execution unit 183, and the speech processing unit 187 implement the function of the application program.

The application program 122 may include a plurality of program modules which is recognized by the user as a plurality of application programs.

The key code API 123 is a program module which is callable by the function of the application program in a state where the CPU of the control unit 140 executes the application program 122. If the CPU of the control unit 140 executes the key code API 123, the allocation of a function to an operator in the key operation unit 16 (FIG. 1) and the lock state of an operation of the operator can be controlled. In this embodiment, for convenience of understanding, the operating system 121 and the application program 122 are shown as separate configurations. If the control unit 140 executes the key code API 123, the key code API 123 operates as a part of the OS 150 being executed. In other words, the key code API 123 includes the OS 150.

The control unit 140 displays a home screen by the function of the OS 150. The home screen is an initial screen during the execution of the OS 150, and the OS 150 controls the image processing unit 160 and the display control unit 170 to display the home screen. In a state where the home screen is displayed, the selection of the application program 122, the activation (execution) of the application program 122, and the end of the application program 122 can be instructed by the operation of the key operation unit 16. On the home screen, it is possible to perform setting relating to the application program 122 or the OS 150.

If the control unit 140 executes the application program 122, the function execution unit 183 executes the function of the application program. The function execution unit 183 controls the image processing unit 160 and the display control unit 170 to display a screen for an application program. The function execution unit 183 executes, for example, AR display by the function of the application program. In this case, the function execution unit 183 controls the camera 61 by the imaging processing unit 181 to execute imaging, analyzes captured image data by the image analysis unit 182 to recognize an object, and displays characters or image of content according to the position of the recognized object. The screen displayed by the function execution unit 183 is, for example, a screen on which information relating to the application program, such as content, is disposed over the entire displayable area of the image display unit 20. In this case, it is possible to increase visibility of content and to allow the user to feel a distinctive sense of immersion in the head-mounted display device. The screen displayed by the function execution unit 183 can be displayed over the entire displayable area so as to hide a screen (for example, the home screen) relating to the function of the OS 150. For this reason, during the execution of the application program 122, it is possible to turn user's awareness to the operation and manipulation of the application program 122 without preventing the user to feel the type or the presence of the OS 150.

The image processing unit 160 acquires an image signal included in content. The image processing unit 160 separates synchronization signals, such as a vertical synchronization signal VSync and a horizontal synchronization signal HSync, from the acquired image signal. The image processing unit 160 generates a clock signal PCLK using a phase locked loop (PLL) circuit or the like (not shown) using the period of the separated vertical synchronization signal VSync or horizontal synchronization signal HSync. The image processing unit 160 converts an analog image signal with the synchronization signal separated to a digital image signal using an A/D conversion circuit or the like (not shown). The image processing unit 160 stores the digital image signal after conversion in the RAM of the control unit 140 as image data (in the drawing, Data) of a target image for every frame. Image data is, for example, RGB data.

If necessary, the image processing unit 160 may perform resolution conversion processing for converting resolution of image data to resolution suitable for the right display drive unit 22 and the left display drive unit 24. The image processing unit 160 may perform image adjustment processing for adjusting luminance or saturation of image data, 2D/3D conversion processing for creating 2D image data from 3D image data or generating 3D image data from 2D image data, and the like.

The image processing unit 160 transmits the clock signal PCLK, the vertical synchronization signal VSync, the horizontal synchronization signal HSync, and image data Data stored in the RAM through the transmission units 51 and 52. The transmission units 51 and 52 function as a transceiver and execute serial transmission between the control device 10 and the image display unit 20. Image data Data transmitted through the transmission unit 51 is referred to as “right-eye image data”, and image data Data transmitted through the transmission unit 52 is referred to as “left-eye image data”.

The display control unit 170 generates a control signal for controlling the right display drive unit 22 and the left display drive unit 24, and controls the generation and emission of image light by each of the right display drive unit 22 and the left display drive unit 24 according to the control signal. Specifically, the drive on/off of the right LCD 241 by a right LCD control unit 211 and the drive on/off of a right backlight 221 by a right backlight control unit 201 are controlled. The display control unit 170 controls the drive on/off of the left LCD 242 by a left LCD control unit 212 and the drive on/off of a left backlight 222 by a left backlight control unit 202.

The speech processing unit 187 acquires a speech signal included in content, amplifies the acquired speech signal, and outputs the speech signal to the right earphone 32 and the left earphone 34. The speech processing unit 187 acquires speech picked up by the microphone 63 and converts speech to digital speech data. The speech processing unit 187 may perform processing set in advance on digital speech data.

The image display unit 20 includes an interface 25, a right display drive unit 22, a left display drive unit 24, a right light guide plate 261 as a right optical image display unit 26, a left light guide plate 262 as a left optical image display unit 28, a camera 61, a vibration sensor 65, and a nine-axis sensor 66.

The vibration sensor 65 is constituted using an acceleration sensor, and for example, as shown in FIG. 1, is embedded near the end portion ER of the right optical image display unit 26 in the right holding unit 21. When the user performs an operation (knock operation) to tap on the end portion ER, the vibration sensor 65 detects vibration by the operation and outputs a detection result to the control unit 140. The control unit 140 detects a user's lock operation by the detection result of the vibration sensor 65.

The nine-axis sensor 66 is a motion sensor which detects acceleration (three-axis), angular velocity (three-axis), and terrestrial magnetism (three-axis). When the image display unit 20 is mounted on the head of the user, the control unit 140 can detect motion of the head of the user based on a detection value of the nine-axis sensor 66. For example, the control unit 140 can estimate the magnitude of the inclination of the image display unit 20 and the direction of the inclination based on the detection value of the nine-axis sensor 66.

The interface 25 includes connectors to which the right cord 42 and the left cord 44 are connected. The interface 25 outputs the clock signal PCLK, the vertical synchronization signal VSync, the horizontal synchronization signal HSync, and image data Data output from the transmission unit 51 to corresponding reception units (Rx) 53 and 54. The interface 25 outputs the control signal transmitted from the display control unit 170 to the corresponding reception units 53 and 54 and the right backlight control unit 201 or the left backlight control unit 202.

The interface 25 is an interface which connects the camera 61, the vibration sensor 65, and the nine-axis sensor 66. A detection result of vibration by the vibration sensor 65, and detection results of acceleration (three-axis), angular velocity (three-axis), and terrestrial magnetism (three-axis) by the nine-axis sensor 66 are transmitted to the control unit 140 through the interface 25.

The right display drive unit 22 includes the right backlight 221, the right LCD 241, and the right projection optical system 251 described above. The right display drive unit 22 further includes the reception unit 53, the right backlight (BL) control unit 201 which controls the right backlight (BL) 221, and the right LCD control unit 211 which drives the right LCD 241.

The reception unit 53 operates as a receiver corresponding to the transmission unit 51, and executes serial transmission between the control device 10 and the image display unit 20. The right backlight control unit 201 drives the right backlight 221 based on the input control signal. The right LCD control unit 211 drives the right LCD 241 based on the clock signal PCLK, the vertical synchronization signal VSync, the horizontal synchronization signal HSync, and right-eye image data Data input through the reception unit 53.

The left display drive unit 24 has the same configuration as the right display drive unit 22. The left display drive unit 24 includes the left backlight 222, the left LCD 242, and the left projection optical system 252. The left display drive unit 24 further includes the reception unit 54, the left backlight control unit 202 which drives the left backlight 222, and the left LCD control unit 212 which drives the left LCD 242.

The reception unit 54 operates as a receiver corresponding to the transmission unit 52, and executes serial transmission between the control device 10 and the image display unit 20. The left backlight control unit 202 drives the left backlight 222 based on the input control signal. The left LCD control unit 212 drives the left LCD 242 based on the clock signal PCLK, the vertical synchronization signal VSync, the horizontal synchronization signal HSync, and right-eye image data Data input through the reception unit 54. The right backlight control unit 201, the right LCD control unit 211, the right backlight 221, and the right LCD 241 are collectively referred to as a right “image light generation unit”. Similarly, the left backlight control unit 202, the left LCD control unit 212, the left backlight 222, and the left LCD 242 are collectively referred to as a left “image light generation unit”.

FIG. 3 is a diagram showing a setting example of a key code by the key code API 123.

In this example, lock setting for each operator (in the drawing, written as “Button”) in the key operation unit 16 is shown. Specifically, lock setting (in the drawing, written as “function at lock (HW)”) by hardware of each operator and lock setting (in the drawing, written as “function at lock (SW)”) by software are included.

Lock by hardware corresponds to an operation of the lock button 302. When switching to a lock state is performed by an operation of the lock button 302, setting regarding whether or not each operator is locked is performed as illustrated in FIG. 3. Lock by software corresponds to the operation of the key code API 123. By the function of the application program 122, when the CPU of the control unit 140 calls the key code API 123, setting regarding whether or not each operator is locked is performed as illustrated in FIG. 3.

In FIG. 3, a function which is allocated to each operator is set (in the drawings, written as “Description”). The allocation of a function of an operator may be determined by the operating system 121, or the key code API 123 may change or add the allocation determined by the operating system 121.

For example, the power button 301 (in the drawing, written as “Power Button”) is allocated with functions for three operations of a press operation (short press) for three seconds or less, long press for more than three seconds and eight seconds or less, and long press for more than eight seconds. Furthermore, lock by hardware and lock by software can be set for each of the three operations.

For example, the lock button 302 (in the drawing, written as “Key Lock Button”) is allocated with functions for two operations of a press operation (short press) for eight seconds or less and long press for more than eight seconds. Lock by hardware and lock by software can be set for each of the two operations.

In addition, in the example of FIG. 3, a function of calling the key code API 123 and performing software lock can be set as to whether or not to perform lock.

In the example of FIG. 3, when lock by hardware is performed, that is, when the lock state is set by an operation of the lock button 302, operations of substantially all operators are locked. The operations to be not locked are an operation of the lock button 302, a long press operation of the power button 301 for more than eight seconds, an operation of the home button 342, and an operation of the reset button 350.

When lock by software is performed, that is, when the key code API 123 is called and executed, operations of substantially all operators are locked. The operations to be not locked are a short press operation of the lock button 302, a long press operation of the power button 301 for more than eight seconds, an operation of the home button 342, and an operation of the reset button 350.

The OS 150 displays the home screen corresponding to an operation of the home button 342, and is not allocated with other operations. In regard to the home button 342, enable or disable of an operation can be set.

If the CPU of the control unit 140 reads and executes the key code API 123, lock by software of FIG. 3 is placed in the “lock state”, the home button 342 is disabled, and operations of other operators are locked. If the execution of the key code API 123 is stopped, lock by software is released, the home button 342 is enabled, and lock of other operators is released.

If the lock button 302 is operated, the lock state and release of lock by hardware are switched. In the setting shown in FIG. 3, if setting is performed such that software lock when the lock button 302 is operated is locked, the lock of the key code API 123 is disabled in a state locked by the lock button 302.

In this way, in the head-mounted display device 100, it is possible to perform setting for disabling or locking an operation of each operator in the key operation unit 16, and to implement the disable or lock state by the CPU of the control unit 140 executing the key code API 123.

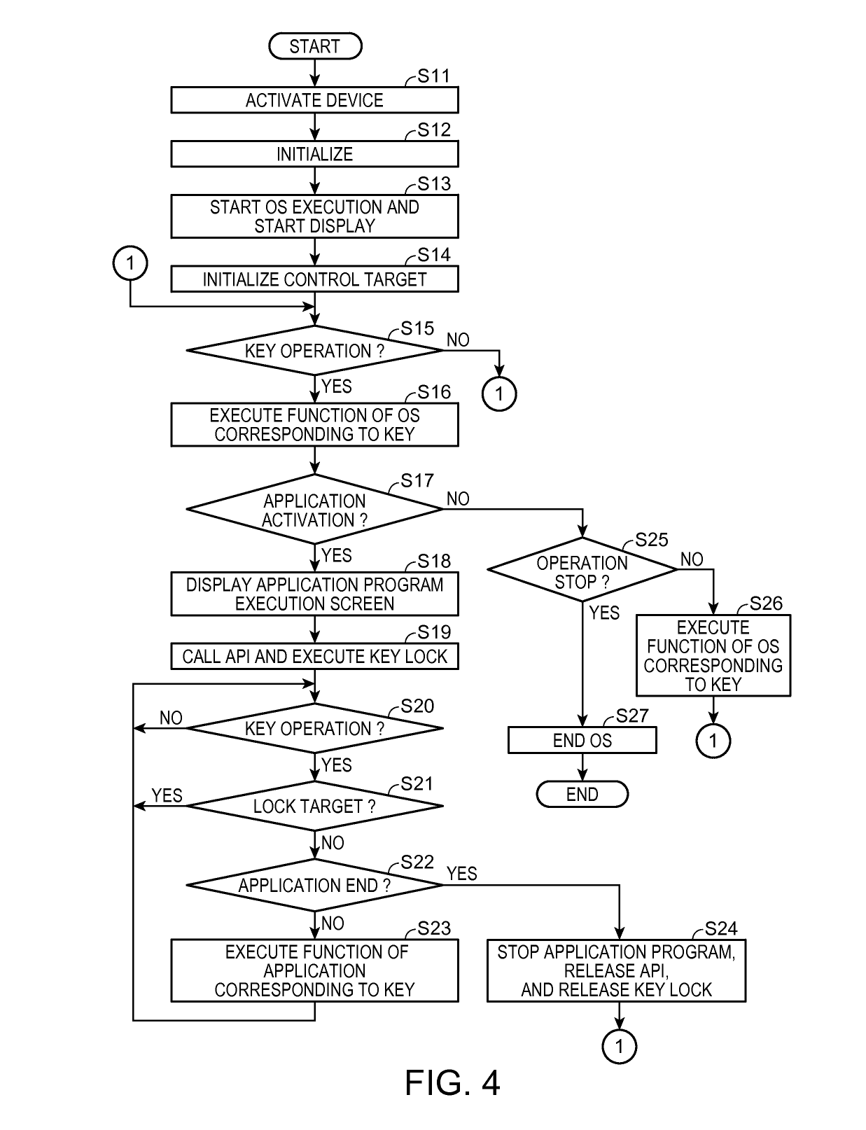

FIG. 4 is a flowchart showing the operation of the head-mounted display device 100.

If the head-mounted display device 100 is switched from power off to power on by an operation of the power button 301, the CPU of the control unit 140 is activated (Step S11). The CPU of the control unit 140 executes a basic control program stored in the ROM (not shown) of the control unit 140 to initialize the control unit 140 and peripheral circuits (Step S12). The CPU of the control unit 140 reads the operating system 121 designated by the basic control program from the storage unit 120 and executes the operating system 121 to start the operation of the OS 150, and displays a screen for the OS 150 by the image processing unit 160 and the display control unit 170 (Step S13).

Subsequently, the OS 150 initializes each unit of the head-mounted display device 100 controlled by the OS 150 (Step S14), and transits to a state where the function of the OS 150 or the application program can be executed.

Here, the control unit 140 detects an operation of an operator of the key operation unit 16 (Step S15), and waits until an operation is performed (Step S15; NO). If any operator of the key operation unit 16 is operated (Step S15; YES), the function of the OS 150 corresponding to the operated key is executed (Step S16).

Here, the control unit 140 determines whether or not the operation detected in Step S15 is an operation to instruct the execution of the application program. 122 (Step S17). When operation is an operation to instruct the execution of the application program 122 (Step S17; YES), the CPU of the control unit 140 executes the application program 122. The function execution unit 183 executes the function of the application program, and displays a screen for the application program by the image processing unit 160 and the display control unit 170 (Step S18). Furthermore, the key code API 123 which is set to perform calling in the application program 122 is read from the storage unit 120 and executed (Step S19). In Step S19, the key code API 123 executes lock for an operation of the key operation unit 16.

Thereafter, the control unit 140 detects an operation for an operator of the key operation unit 16 by the function of an input/output drive in the OS 150 (Step S20), and waits until there is an operation (Step S20; NO). When an operation is detected by the function of the OS 150 (Step S20; YES), the control unit 140 determines whether or not the detected operation is an operation to be locked with reference to a setting state by the key code API 123 (Step S21). When the detected operation is an operation to be locked (Step S21; YES), the control unit 140 returns to Step S20. When the detected operation is not an operation to be locked (Step S21; NO), the control unit 140 determines whether or not the detected operation is an operation to instruct the end of the execution of the application program 122 (Step S22). When the operation is not an operation to instruct the end of the execution of the application program 122 (Step S22; NO), the control unit 140 executes a function corresponding to the application program corresponding to the operated operator (key) by the function execution unit 183 (Step S23). Thereafter, the control unit 140 returns to Step S20.

When the detected operation is an operation to instruct the end of the execution of the application program 122 (Step S22; YES), the control unit 140 ends the execution of the application program 122. Here, the control unit 140 releases the key code API 123 called by the application program 122 (Step S24). With this, lock by software of the operation of the key operation unit 16 is released. Thereafter, the control unit 140 returns to Step S15.

When the operation detected in Step S15 is not an operation to instruct the execution of the application program 122 (Step S17; NO), the control unit 140 determines whether or not the operation is an operation to instruct the stop of the OS 150 (Step S25). When the operation is not an operation to instruct the stop of the OS 150 (Step S25; NO), the control unit 140 executes the function of the OS 150 corresponding to the operated operator (Step S26), and returns to Step S15. When the operation is an operation to instruct the stop of the OS 150 (Step S25; YES), the control unit 140 ends the OS 150 (Step S27), shuts down the head-mounted display device 100, and ends this processing.

In the flowchart of FIG. 4, an example of flow control in which the control unit 140 waits for an operation of the key operation unit 16 (Steps S15 and S20), and the processing is advanced after an operation of the key operation unit 16 is detected has been described. The operation of the head-mounted display device 100 is not limited thereto, and when an operation of the key operation unit 16 is performed, the input information acquisition unit 110 may interrupt the control unit 140, and the control unit 140 may perform interrupt control. In this case, the control unit 140 executes the processing after Step S16 or the processing after Step S21 by the interrupt control.

As described above, the control device 10 in the head-mounted display device 100 of the embodiment to which the invention is applied is a device which is connected to the head-mounted image display unit 20 and controls the display of the image display unit 20. The control device 10 includes the key operation unit 16 which receives an operation, and the control unit 140 which executes the general-purpose OS 150 and the application program operating on the OS 150. The OS 150 has the control function which is executed when the operating unit receives a predetermined operation, and includes a key code API 123 which is callable by the function of the application program and limits the execution of the control function. For this reason, it is possible to limit operation, which is executed by the OS 150 when a predetermined operation is received, by the function of the application program. Therefore, it is possible to relax the restriction to the specification of the OS 150 in terms of the function of the application program. For example, even if the home button 342 is operated during the execution of the application program, operation can be performed such that the home screen of the OS 150 is not displayed.

The control device 10 includes the display control unit 170 which controls the image display unit 20 to display an image. The control unit 140 allows the image display unit 20 to display a screen for the OS 150 during the execution of the application program by the control function. The control unit 140 allows the display of the home screen, which is the initial screen of the OS 150, by the control function of the OS 150. The home screen is a screen which is displayed by the image display unit 20 before the application program is executed after the activation of the OS 150. In this way, the application program can limit a function of the OS 150 displaying the home screen. With this, the application program can perform the control such that the display content does not return to a screen before the execution of the application program during the execution of the application program.

The key operation unit 16 includes an operation region or an operator for a control function, and the function executed by the OS 150 corresponding to the operation can be limited by the function of the application program.

The control unit 140 can release the key code API 123 after the application program is stopped during the execution of the OS 150, and can execute the control function when the key operation unit 16 receives a predetermined operation. For this reason, it is possible to release the limitation of the function of the OS 150 by stopping the application program.

The key operation unit 16 is configured to receive a plurality of operations, and the control unit 140 can execute a plurality of control functions corresponding to an operation of the operating unit, and limits the execution of at least one of a plurality of control functions at the time of the execution of the key code API 123. For this reason, it is possible to limit part or all of the functions by the function of the application program in a configuration in which the OS 150 can execute a plurality of functions corresponding to a plurality of operations.

### Second Embodiment

Subsequently, a second embodiment to which the invention is applied will be described.

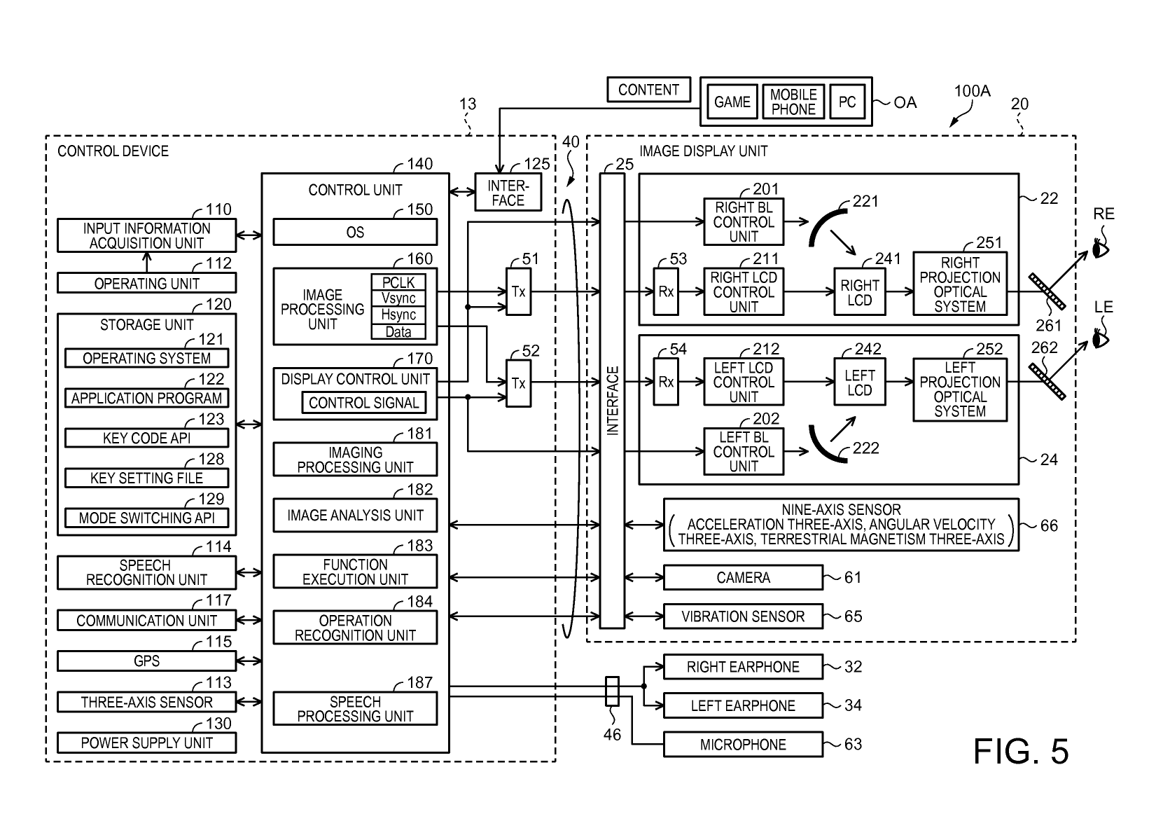

FIG. 5 is a functional block diagram constituting a head-mounted display device 100A according to a second embodiment of the invention.

The configuration of the head-mounted display device 100A is common to the head-mounted display device 100 of the first embodiment described above, except that a control device 13 (electronic apparatus), instead of the control device 10, is provided. In the head-mounted display device 100A, the parts common to the head-mounted display device 100 are represented by the same reference numerals, and the drawing and description thereof will not be repeated.

The control device 13 includes an operating unit 112, instead of the operating unit 111 in the control device 10 (FIG. 2). The operating unit 112 is connected to each operator of the key operation unit 17 in the control device 13. The operating unit 112 detects an operation of each operator and outputs an operation signal corresponding to the detected operator to the input information acquisition unit 110. The input information acquisition unit 110 acquires an input content input by the user with the control device 13 based on the signal input from the operating unit 112.

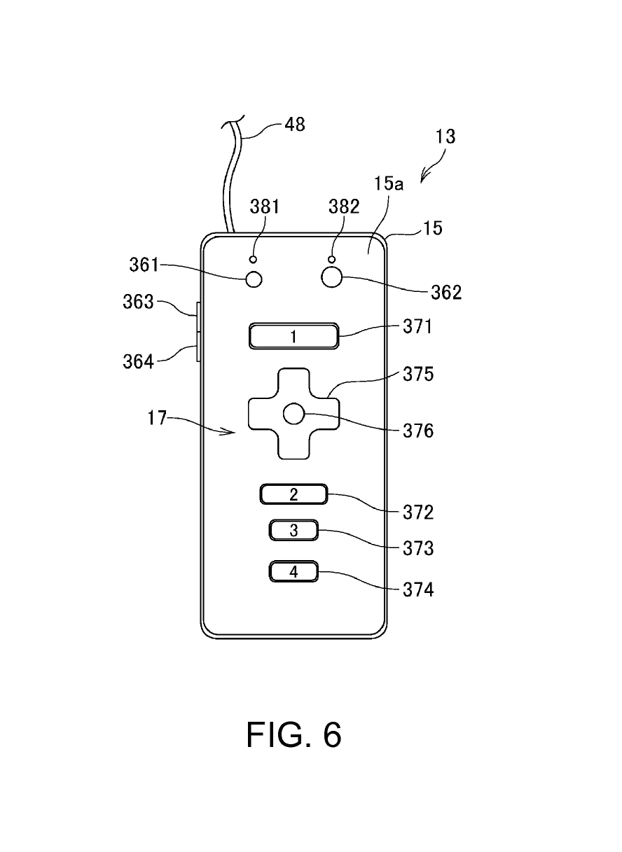

FIG. 6 is an appearance diagram of the control device 13.

The control device 13 has a substantially box-like control device main body 15, and a key operation unit 17 (operating unit) having a plurality of key switches is provided in an upper surface 15a of the control device main body 15. The key operation unit 17 has a power button 361 which switches the power on and off of the head-mounted display device 100A, and a lock button 362 which switches lock/lock release of an operator in the key operation unit 17. The power button 361 and the lock button 362 are operators relating to the basic operation of the control device 13.

The key operation unit 17 includes a volume up key 363 and a volume down key 364 for volume adjustment, four function keys 371, 372, 373, and 374 to which functions are allocable, and a direction key unit 375. The direction key unit 375 includes four direction keys corresponding to up, down, right, and left, and a determination key 376 disposed at the center. These are operators which are primarily operated by the user during the execution of an operating system (OS) 150 or an application program described below.

In a side surface of the control device main body 15, a reset button (not shown) may be disposed. Similarly to the reset button 350 described above, the reset button can be an operator which resets the operation of the head-mounted display device 100A. For example, similarly to the reset button 350, the reset button of the control device main body 15 can be a hardware switch in order to prevent an erroneous operation. A configuration can be made in which a hole is provided in the side surface of the control device main body 15 and a reset button constituted of a tactile switch is disposed in the bottom portion of the hole so as to be operable by a pin or the like passing through the hole in the side surface.

Each operator in the key operation unit 17 may be constituted of a hardware switch, such as a tactile switch or a push button switch. Furthermore, each operator may be constituted of a touch type switch in which a detection unit (not shown) configured to detect a touch operation and a display unit (not shown) configured to display the position of the operator are combined.

In the second embodiment, the lock button 362 is an operator which performs an operation to instruct a full lock state, an individual lock state, and a lock release state as described below, and corresponds to a first operator, and an operation of the lock button 362 corresponds to a first operation. Furthermore, the volume up key 363, the volume down key 364, the function keys 371, 372, 373, and 374, the direction key unit 375, and the determination key 376 correspond to an operator according to the invention, and a second operator and a third operator according to the invention. Furthermore, the operations of the operators correspond to a second operation and a third operation. Specifically, it can be said that the operations of the function keys 371, 372, 373, and 374 where the allocation of functions to operators can be changed correspond to the second operation and the third operation according to the invention.

However, as described below, the first operation, the second operation, and the third operation according to the invention are not limited to the operations of the key operation unit 17.

The control device 13 includes LED indicators 381 and 382 as a notification unit which indicates the operation state of the head-mounted display device 100A. The LED indicator 381 corresponds to the power button 361, is turned on in a state where the head-mounted display device 100A is powered on, and is turned off in a state of power off. While the head-mounted display device 100A executes an activation sequence and/or an end sequence, the LED indicator 381 may blink.

The LED indicator 382 is provided corresponding to the lock button 362, is turned on when the head-mounted display device 100A is in the lock state, and is turned off in a state where lock is released (limit release state).

As shown in FIG. 5, the control device 13 stores an operating system 121, an application program 122, and a key code API 123 in a storage unit 120. These are the same as the control device 10 of the first embodiment. The control device 13 stores a key setting file 128 and a mode switching API 129 in the storage unit 120.

The key code API 123 is a program module which executes key setting when the control unit 140 executes the application program 122. The key setting file 128 is data for setting the allocation of a function to a key in an operation state where the head-mounted display device 100A displays the home screen. The control unit 140 displays the home screen by the function of the operating system 121 or the application program 122. That is, a function of displaying the home screen and selectively activating application program 122 corresponding to a user's operation on the home screen is provided by the operating system 121 or the application program 122.

The mode switching API 129 is a program module which executes key setting when the control unit 140 executes the application program 122.

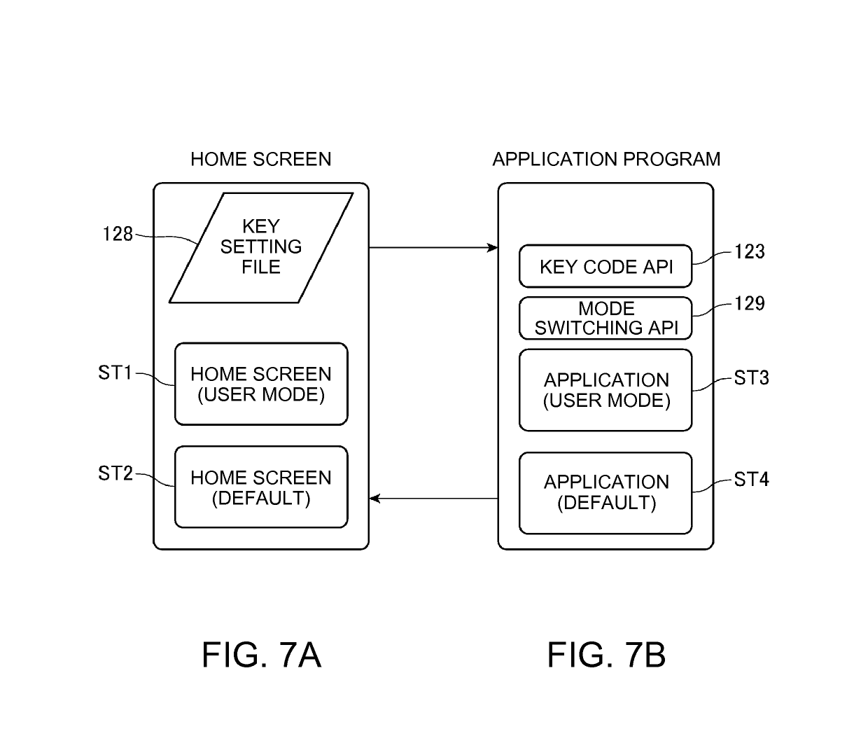

FIG. 7 is an explanatory view showing transition of the operation state of the head-mounted display device 100A. (A) in FIG. 7 shows a state where the head-mounted display device 100A displays the home screen, and (B) in FIG. 7 shows a state where a screen for the application program 122 is displayed. As described above, the control unit 140 may display the home screen by executing the application program 122 having a function of displaying the home screen.

A state where the home screen is displayed can be regarded as a basic operation state of the head-mounted display device 100A. For example, after power is supplied to the head-mounted display device 100A, before the execution of the application program 122 is started, the home screen is displayed. If the application program 122 is executed in a state where the home screen is displayed, the head-mounted display device 100A transits to a state where the screen for the application program 122 is displayed. If the execution of the application program 122 ends, the head-mounted display device 100A transits to a state where the home screen is displayed. The end of the execution of the application program 122 includes the end of the execution according to a user's operation, the end of the execution when a condition set in advance is established, and abnormal end due to an error occurring during the execution of the application program 122.

When processing for starting the execution of the application program 122 is included in the activation sequence which is executed when the head-mounted display device 100A is activated, a screen which is displayed after the activation of the head-mounted display device 100A becomes a screen for the application program 122.

In a state where the home screen is displayed, the head-mounted display device 100A can switch between a user mode ST1 and a default mode ST2. In the default mode ST2, the allocation of a function to each operator of the key operation unit 17 becomes the allocation determined by initial setting (default setting) of the head-mounted display device 100A. In contrast, the allocation of a function of each operator in the user mode ST1 can be arbitrarily set. Setting of the allocation in the user mode ST1 is stored in the key setting file 128. That is, the allocation of a function of an operator in the user mode ST1 can be changed by rewriting the key setting file 128.

In regard to key allocation during the execution of the application program 122, the head-mounted display device 100A can switch between a user mode ST3 and a default mode ST4. In the default mode ST4, the allocation of a function to each operator of the key operation unit 17 becomes the allocation determined by initial setting (default setting) for the application program of the head-mounted display device 100A. In contrast, the allocation of a function of each operator in the user mode ST3 can be arbitrarily set. The allocation in the user mode ST3 is set by the key code API 123. The allocation of a function of an operator in the user mode ST3 can be changed by changing setting of the key code API 123.

Editing of the key setting file 128 and the key code API 123 may be performed by the user. For example, a vendor which supplies and sells the head-mounted display device 100A, or a software vendor which provides the application program 122 may edit the key setting file 128 and/or the key code API 123. In this case, editing of the key setting file 128 and/or the key code API 123 by the user may be limited.

In a state where the home screen is displayed, selection of the user mode ST3 and the default mode ST4 when the execution of the application program 122 is started is performed by the mode switching API 129. The mode switching API 129 sets an operation mode to be executed corresponding to each of a plurality of application programs 122 stored in the storage unit 120. The control unit 140 selects and executes the user mode ST3 or the default mode ST4 by calling the mode switching API 129 at the time of the execution of the application program 122.

Selection of the user mode ST1 and the default mode ST2 when the home screen is displayed is performed according to setting of the key setting file 128. The key setting file 128 includes setting of an operation mode to be selected at the time of the display of the home screen, in addition to the allocation of each operator of the key operation unit 17.

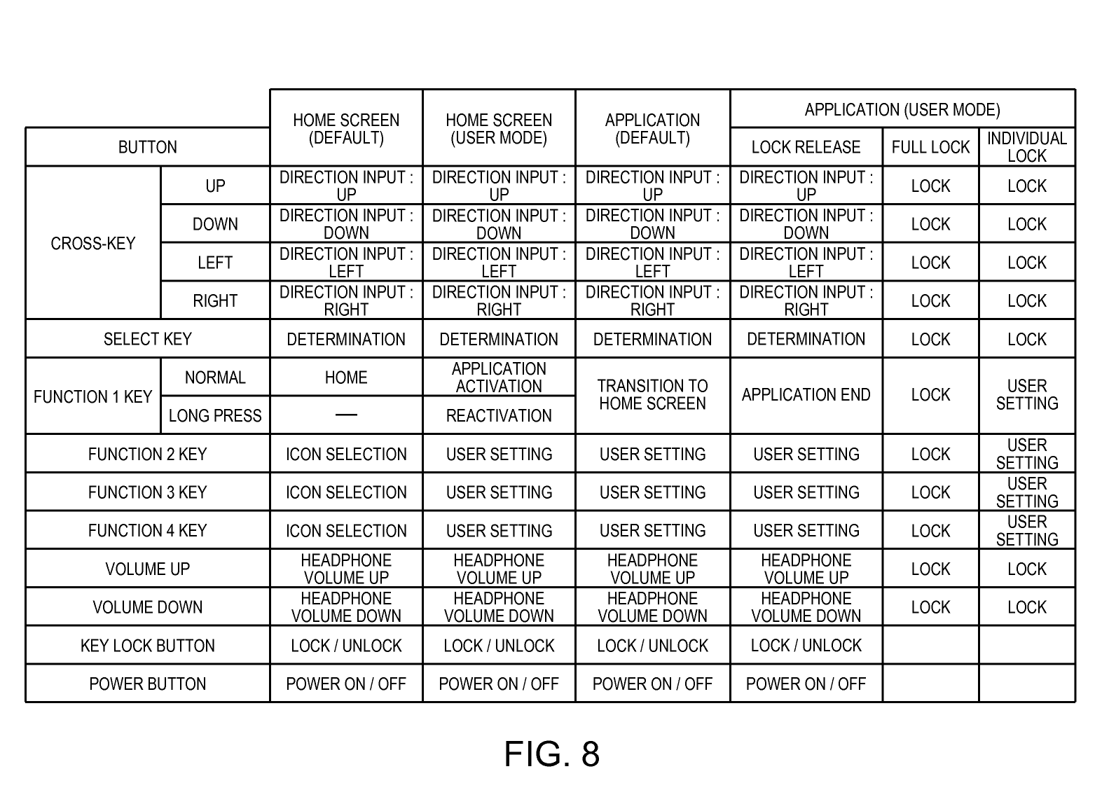

FIG. 8 is a diagram showing an example of setting relating to a key code and a lock state in the head-mounted display device 100A.

In this example, a function allocated to each operator (in the drawings, written as “Button”) in the key operation unit 17 and setting relating to lock are shown. The allocation is implemented by the key code API 123 and the key setting file 128 as described above.

In the drawing, the power button 361 is written as “Power Button”, the lock button 362 is written as “Key Lock Button”, the volume up key 363 is written as “Volume Up”, and the volume down key 364 is written as “Volume Down”. The function keys 371, 372, 373, and 374 are written as “Function 1 key” to “Function 4 key”, the direction key unit 375 is written as “Cross-Key”, and the determination key 376 is written as “Select key”.

The key allocation in the default mode ST2 on the home screen can be called initial setting of the operating system 121. In contrast, in the user mode ST1 on the home screen, for example, the functions which are allocated to the function keys 371, 372, 373, and 374 can be changed. In the example of FIG. 8, a function of activating the application program 122 is allocated to a normal press operation of the function key 371. Furthermore, a function of reactivating the head-mounted display device 100A is allocated to a long press operation of the function key 371. In the user mode ST1, although a configuration may be made in which the allocation to all operators in the key operation unit 17 can be changed, if operators where the allocation can be changed are limited to some operators, it is possible to prevent trouble due to erroneous setting.

Out of the key allocation in the default mode ST4 during the execution of the application program 122, setting of functions allocated to the function keys 371, 372, 373, and 374 (“Function 1 key” to “Function 4 key”) can be changed. The functions allocated to the function keys 371, 372, 373, and 374 can be set by a software vendor which provides the application program 122 according to the specification of the application program 122 or the like.

In the user mode ST3 during the execution of the application program 122, a lock state where an operation recognized by an operation recognition unit 184 is locked is included.

That is, in the user mode ST3, switching is performed among a lock release state (limit release state) where an operation is not locked, a full lock state (full limit state) where operations excluding some operations are locked, and an individual lock state (individual limit state) where operations set to be locked are locked.

The operating unit 112 is connected to each operator of the key operation unit 17 provided in the control device main body 15, detects an operation of each operator, and outputs an operation signal corresponding to the detected operator to the input information acquisition unit 110. The input information acquisition unit 110 acquires an input content input by a user's operation based on the signal input from the operating unit 112 and outputs data indicating the input content to the control unit 140.

The control unit 140 includes the operation recognition unit 184 which recognizes an operation.

The operation recognition unit 184 detects and recognizes an input to the head-mounted display device 100A. The operation recognition unit 184 recognizes an input to the key operation unit 17 based on data input from the input information acquisition unit 110.

The operation recognition unit 184 may detect and recognize an input based on a captured image of the camera 61. In this case, the operation recognition unit 184 extracts an image of an indicator from the captured image of the camera 61 and detects the position of the image of the indicator. The indicator is, for example, a user's hand or a pen-like or rod-shaped device. The position to be detected may be the tip of the indicator or a set position, or a change in position may be detected.

In this case, the operation recognition unit 184 detects and recognizes a position input operation or a gesture operation based on the position of the indicator.

In the position input operation, for example, the operation recognition unit 184 displays an image for input on the image display unit 20 by the display control unit 190. Although a form corresponding to a so-called virtual keyboard or a software keyboard is provided, an image to be displayed is not limited to a keyboard shape, and may be an image which can constitute a graphical user interface (GUI) corresponding to one or a plurality of operations. The operation recognition unit 184 recognizes an input by determining an image corresponding to the position of the indicator. Furthermore, when the indicator is detected from the captured image, an image for GUI may be pop-up displayed.

In the gesture operation, when it is determined that the position, direction, or motion of the indicator detected from the captured image of the camera 61 corresponds to a gesture set in advance, the operation recognition unit 184 detects a gesture input. If a plurality of gestures are set in advance, a plurality of kinds of operations can be performed.

When an image of a marker for input, such as a two-dimensional code or a barcode, is detected from the captured image of the camera 61, the operation recognition unit 184 detects a marker reading input. In this case, the operation recognition unit 184 may decode the marker detected from the captured image to acquire data and may recognize the marker reading input as an input operation of data. Furthermore, an operation set in advance may be recognized in association with the shape, color, and pattern of the marker.

When the speech processing unit 187 analyzes speech picked up by the microphone 63, and determines that speech is a speech command set in advance, the operation recognition unit 184 detects and recognizes an input of the speech command.

When a change in detection value of the nine-axis sensor 66 in the image display unit 20 corresponds to a change indicating an operation to knock on the image display unit 20, the operation recognition unit 184 detects and recognizes a knock operation on the image display unit 20.

In this way, the operation recognition unit 184 can detect and recognize an operation to an operator of the key operation unit 17, and can allocate the operation of each operator of the key operation unit 17 to the first operation, the second operation, or the third operation.

The operation recognition unit 184 can allocate an operation detected and recognized based on the captured image of the camera 61 to the first operation, the second operation, or the third operation. In this case, a position input operation, a gesture operation, and an operation by a marker reading input may be respectively set as the first operation, the second operation, and the third operation. Furthermore, in a configuration in which a plurality of kinds of operations can be performed using an image for GUI by the position input operation, a plurality of kinds of operations may be respectively set as the first operation, the second operation, and the third operation. In a configuration in which a plurality of kinds of gestures can be detected and recognized as gesture operations, a plurality of kinds of operations may be respectively set as the first operation, the second operation, and the third operation. In a configuration in which a plurality of kinds of inputs can be detected and recognized according to the kind of marker read in the marker reading input, a plurality of kinds of inputs may be respectively set as the first operation, the second operation, and the third operation. Furthermore, the operation recognition unit 184 may set the recognition result of speech picked up by the microphone 63 as the first operation, the second operation, or the third operation, and may respectively set a plurality of speech commands as the first operation, the second operation, and the third operation. A knock operation may be set as the first operation, the second operation, or the third operation.

The operations detected by the operation recognition unit 184 can be classified broadly into a key operation to an operator of the key operation unit 17 and a non-key operation detected and recognized by a unit other than the key operation unit 17. A non-key operation is an operation which is recognized by the operation recognition unit 184 based on a captured image of the camera 61, speech picked up by the microphone 63, motion detected by the nine-axis sensor 66 as a motion sensor, or the like.

As described above, in this embodiment, the operations recognized by the operation recognition unit 184 may be associated with the first operation, the second operation, and the third operation regardless of a key operation or a non-key operation.

In particular, if a first operation to instruct switching (transition) of the full lock state, the individual lock state, and the lock release state is associated with a key operation, since a state relating to lock of another operation can be switched by the key operation, the user can perform an intuitive operation. Furthermore, a specific operator (for example, the lock button 362) of the key operation unit 17 is associated with the first operation, whereby a simple operation can be performed more intuitively. When the key operation unit 17 has a touch panel, a key operation includes a touch operation, and is not limited to an operation to physically move an operator. If an operation to physically move an operator is associated with the first operation, the effect described above is obtained.

The function execution unit 183 executes a function corresponding to an operation recognized by the operation recognition unit 184. When specifying a function corresponding to an operation recognized by the operation recognition unit 184, the function execution unit 183 refers to the key setting file 128 or acquires setting by the key code API 123 and the mode switching API 129.

The control for disabling an operation in the full lock state and the individual lock state may be performed by one of the input information acquisition unit 110, the function execution unit 183, and the operation recognition unit 184.

For example, the operation recognition unit 184 may determine whether or not a recognized operation corresponds to a locked operation in the full lock state and the individual lock state. In this case, when an operation not corresponding to a locked operation is not recognized, the operation recognition unit 184 passes data of the recognized operation to the function execution unit 183 to execute a function. Furthermore, when it is determined that the recognized operation is a locked operation, processing in which data of an operation is not passed to the function execution unit 183 may be performed.

The function execution unit 183 may determine whether or not an operation recognized by the operation recognition unit 184 corresponds to a locked operation in the full lock state and the individual lock state. In this case, when data of the recognized operation is passed from the operation recognition unit 184, the function execution unit 183 determines whether or not the operation corresponds to a locked operation. When the operation does not correspond to a locked operation, the function execution unit 183 executes a function corresponding to the operation. Furthermore, when it is determined that the operation is a locked operation, a function corresponding to the operation is not executed.

In this way, the entity of the control for disabling or enabling an operation recognized by the operation recognition unit 184 according to setting may be the function execution unit 183, the operation recognition unit 184, or the input information acquisition unit 110.

In the second embodiment, the key code API 123 corresponds to disable setting data, and the key setting file 128 corresponds to home setting data.

In the example of FIG. 8, in regard to the allocation in the lock release state of the user mode ST3, setting of the functions allocated to the function keys 371, 372, 373, and 374 can be changed, and other operators are the same as those in the default mode ST4. The functions allocated to the function keys 371, 372, 373, and 374 can be set regardless of setting in the default mode ST4.

In the full lock state of the user mode ST3, all operators other than the power button 361 and the lock button 362 are set to lock (in the drawing, “Lock”). In this embodiment, the function execution unit 183 or the operation recognition unit 184 locks an operator by a software function, lock is a synonym to disable.

In the individual lock state, it is possible to set whether or not to individually lock operations recognized by the operation recognition unit 184. In the example of FIG. 8, in the individual lock state, operators other than the power button 361, the lock button 362, and the function keys 371, 372, 373, and 374 are locked, and the function keys 371, 372, 373, and 374 can be set individually. This is an example, and a configuration may be made in which other operators are locked individually. For example, in a configuration in which the full lock state, the individual lock state, and the lock release state can be switched by a non-key operation recognized by the operation recognition unit 184, it may be set whether or not to individually lock all operations in the key operation unit 17.

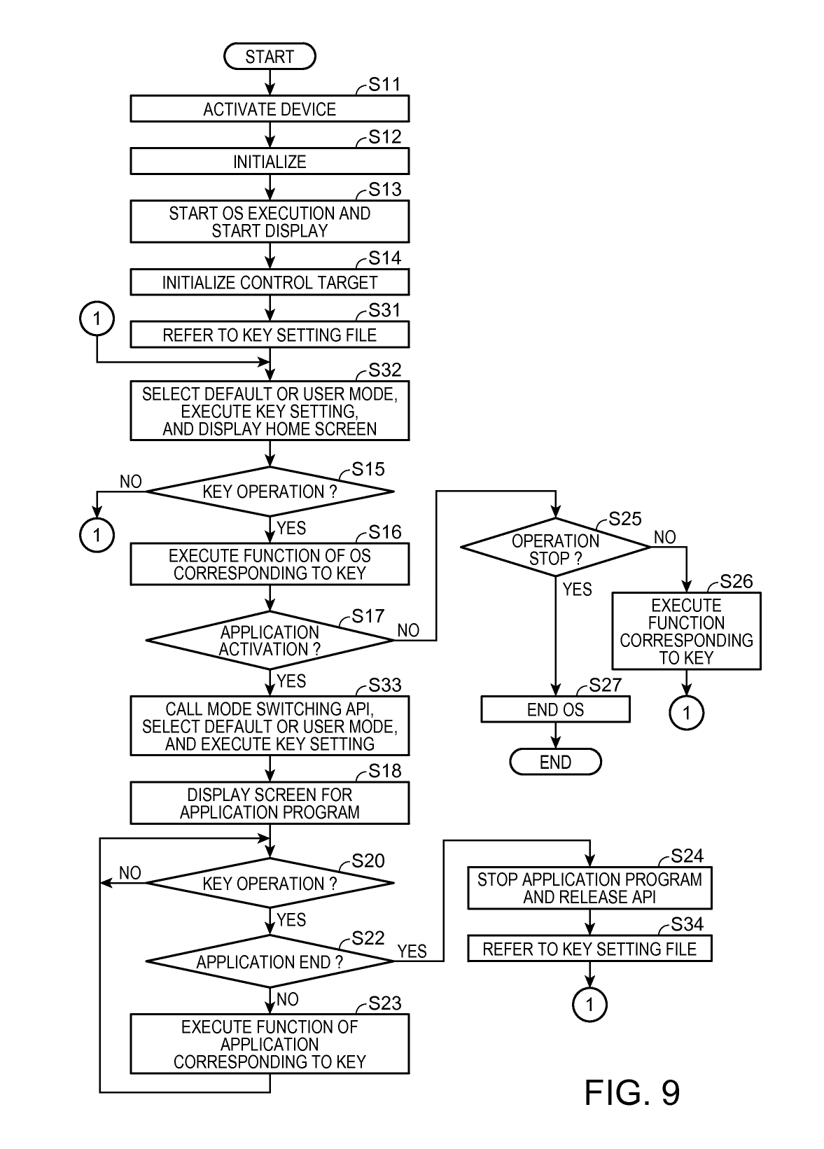

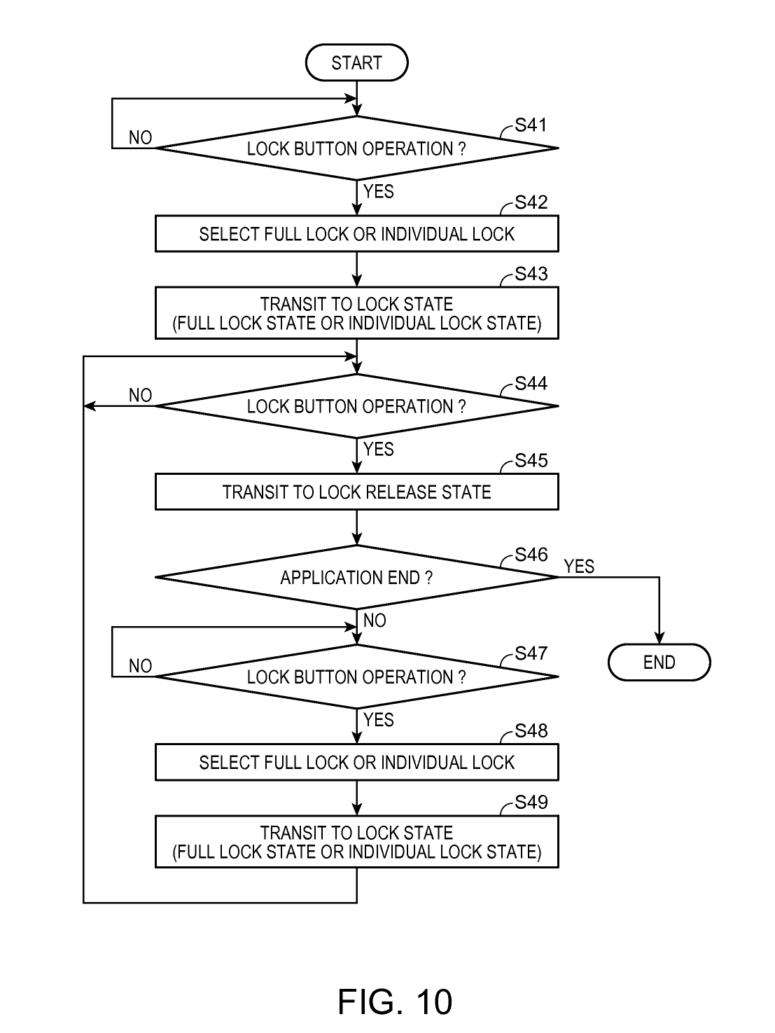

FIGS. 9 and 10 are flowcharts showing the operation of the head-mounted display device 100A. In the operation of FIG. 9, the processing common to the operation of FIG. 4 described in the first embodiment is attached with the same step number. The operation of FIGS. 9 and 10 can be implemented by, for example, the CPU of the control unit 140 executing a program stored in the storage unit 120.

If the head-mounted display device 100 is switched from power off to power on by an operation of the power button 301, the CPU of the control unit 140 is activated (Step S11), and initializes the control unit 140 and peripheral circuits (Step S12). The CPU of the control unit 140 reads the operating system 121 designated by the basic control program from the storage unit 120 and executes the operating system. 121 to start the operation of the OS 150, and displays a screen for the OS 150 by the image processing unit 160 and the display control unit 170 (Step S13).

Subsequently, the OS 150 initializes each unit of the head-mounted display device 100 controlled by the OS 150 (Step S14), and transits to a state where the function of the OS 150 or the application program can be executed.

The control unit 140 selects the user mode ST1 and the default mode ST2 and acquires setting of the allocation of a function to an operator of the key operation unit 17 with reference to the key setting file 128 (Step S31). The control unit 140 selects the user mode ST1 or the default mode ST2, performs the allocation of a function to each operator according to the key setting file 128, and allows the image display unit 20 to display the home screen (Step S32).

Here, the control unit 140 detects an operation (Step S15), and waits until an operation is performed (Step S15; NO). In Step S15, other operations recognizable by the operation recognition unit 184 can be detected without being limited to an operation of the key operation unit 17. If an operation of any operator of the key operation unit 17 or another operation is detected and recognized (Step S15; YES), the control unit 140 executes the function of the OS 150 corresponding to the operation (Step S16).

The control unit 140 determines whether or not the operation detected in Step S15 is an operation to instruct the execution of the application program 122 (Step S17).

When the operation is an operation to instruct the execution of the application program 122 (Step S17; YES), the control unit 140 reads and executes the key code API 123 and the mode switching API 129 set so as to perform calling in the instructed application program 122 (Step S33). In Step S33, the control unit 140 selects the user mode ST3 and the default mode ST4 by the mode switching API 129. Furthermore, in Step S33, the control unit 140 executes the allocation of a function to an operator by the key code API 123.

The control unit 140 executes the application program 122 and displays a screen for the application program 122 by the image display unit 20 (Step S18).

Thereafter, the control unit 140 detects an operation by a function of an input/output driver in the OS 150 (Step S20), and waits until there is an operation (Step S20; NO). In Step S20, other operations recognizable by the operation recognition unit 184 can be detected without being limited to an operation of the key operation unit 17.

When an operation is recognized (Step S20; YES), the control unit 140 determines whether or not the recognized operation is an operation to be locked with reference to a setting state by the key code API 123 (Step S21). When it is determined that the operation is an operation to be locked (Step S21; YES), the control unit 140 returns to Step S20. Furthermore, when it is determined that the operation is not an operation to be locked (Step S21; NO), the control unit 140 determines whether or not the recognized operation is an operation to instruct the end of the execution of the application program 122 (Step S22). When it is determined that the operation is not an operation to instruct the end of the execution of the application program 122 (Step S22; NO), the control unit 140 executes s function of the application program corresponding to the operation by the function execution unit 183 (Step S23). Thereafter, the control unit 140 returns to Step S20.

When it is determined that the recognized operation is an operation to instruct the end of the execution of the application program 122 (Step S22; YES), the control unit 140 ends the execution of the application program 122.

The control unit 140 releases the key code API 123 and the mode switching API 129 called by the application program 122 (Step S24).

The control unit 140 selects the user mode ST1 and the default mode ST2 and acquires setting of the allocation of a function to an operator of the key operation unit 17 with reference to the key setting file 128 for performing the display of the home screen (Step S34), and returns to Step S32.

When the operation detected in Step S15 is not an operation to instruct the execution of the application program 122 (Step S17; NO), the control unit 140 determines whether or not the operation is an operation to instruct the stop of the OS 150 (Step S25). When the operation is not an operation to instruct the stop of the OS 150 (Step S25; NO), the control unit 140 executes the function of the OS 150 corresponding to the operated operator (Step S26), and returns to Step S15. Furthermore, when the operation is an operation to instruct the stop of the OS 150 (Step S25; YES), the control unit 140 ends the OS 150 (Step S27), shuts down the head-mounted display device 100, and ends this processing.

In the flowchart of FIG. 9, an example of flow control in which the control unit 140 waits for an operation of the key operation unit 17 or other operations (Steps S15 and S20), and an processing is advanced after the operation is detected and recognized has been described. The operation of the head-mounted display device 100A is not limited thereto, and the operation recognition unit 184 may wait for an operation of the key operation unit 17 or other operations, and when an operation is detected, may start processing corresponding to the operation by interrupt control. In this case, the control unit 140 executes processing after Step S16 or processing after Step S21 by the interrupt control.

In the operation shown in FIG. 9, when the user mode ST3 is selected in Step S33, in the user mode ST3, the lock release state is placed. Thereafter, if the lock button 362 is operated in a state where a screen for the application program 122 is displayed, transition to the full lock state or the individual lock state is performed, and if the lock button 362 is further operated, transition to the lock release state is performed. The operation of the head-mounted display device 100A corresponding to an operation of the lock button 362 will be described referring to FIG. 10.

In the operation of FIG. 10, the control unit 140 waits for the first operation, that is, an operation of the lock button 362, by the function of the OS 150 (Step S41). The operation of Step S41 is executed after the display of the screen for the application program 122 is started in Step S18. When an operation of the lock button 362 is detected, the control unit 140 determines to be affirmative in Step S41 (Step S41; YES), and determines that there is no key operation in Step S20 (Step S20; NO). When an operation of an operator other than the lock button 362 is detected, it is determined in Step S20 that there is an operation (Step S20; YES), and it is determined in Step S41 that there is no operation (Step S41; NO).

While there is no operation of the lock button 362 (Step S41; NO), the control unit 140 waits for an operation. If an operation of the lock button 362 is detected (Step S41; YES), the full lock state or the individual lock state is selected according to setting of the mode switching API 129 (Step S42). The control unit 140 transits to the lock state selected in Step S42 to disable an operation of an operator set by the key code API 123 (Step S43). With this, in the operation of Steps S20 to S23 (FIG. 9) which are executed in parallel with the operation of FIG. 10, the operation of the set operator is disabled.

The control unit 140 waits for an operation of the lock button 362 (Step S44), and while there is no operation (Step S44; NO), is maintained in a standby state. When the operation of the lock button 362 is detected (Step S44; YES), the control unit 140 transits to the lock release state, and performs the allocation of a function to an operator of the key operation unit 17 by the key code API 123 (Step S45). The control unit 140 determines whether or not an operation to instruct the end of the execution of the application program 122 is performed (Step S46), and when the corresponding operation is performed (Step S46; YES), ends this processing.

In a state where there is no operation to instruct the end of the execution of the application program 122 (Step S46; NO), the control unit 140 waits for the operation of the lock button 362 (Step S47), and while there is no operation (Step S47; NO), is maintained in the standby state. When the operation of the lock button 362 is detected (Step S47; YES), the control unit 140 selects the full lock state or the individual lock state (Step S48).

In Step S48, the control unit 140 may select the full lock state and the individual lock state according to setting of the mode switching API 129. Furthermore, in Step S48, the control unit 140 may select the full lock state and the individual lock state based on a state before transition to the lock release state in Step S45. For example, the same lock state as the state before transition to the lock release state in Step S45 may be selected.

The control unit 140 transits to the lock state selected in Step S48, disables an operation of an operator set by the key code API 123 (Step S49), and returns to Step S44.

In this way, in the head-mounted display device 100A, an operation including the key operation unit 17 is detected and recognized by the operation recognition unit 184. The control unit 140 can execute the full lock state where other operations are disabled corresponding to an operation allocated to transition of the lock state, for example, the operation of the lock button 362. Furthermore, the control unit 140 can execute the individual lock state where operations other than an operation allocated to the first operation are disabled during the execution of the application program 122. Furthermore, the control unit 140 can transit to the lock release state where operations other than an operation allocated to the first operation are detected. The control unit 140 can switch among the full lock state, the individual lock state, and the lock release state corresponding to the first operation and can transit to the full lock state, the individual lock state, and the lock release state. For this reason, it is possible to relax the restriction to the specification of the OS 150, and to appropriately set the correspondence to an operation at the time of the execution of the application program 122.

The head-mounted display device 100A stores, in the storage unit 120, the key code API 123 which sets an operation to be disabled in the individual lock state. The control unit 140 disables operations other than the operation allocated to the first operation according to the key code API 123, whereby an operation to be disabled by the control unit 140 can be set using the key code API 123.

In the head-mounted display device 100A, when the operation allocated to the first operation is recognized in the full lock state or the individual lock state, the control unit 140 transits to the lock release state. For this reason, the first operation is performed, whereby other operations can be effectively switched.

When the operation allocated to the first operation is recognized after transition from the full lock state or the individual lock state to the lock release state, the control unit 140 transits to a state set in advance out of the full lock state and the individual lock state. With this, an operation can be locked by a simple operation.

After the execution of the application program 122 ends, the control unit 140 may display a predetermined home screen and may transit to a state where operations other than the operation allocated to the first operation can be recognized. In this case, the execution of the application program 122 ends, whereby lock can be released. With this, setting of lock of an operation optimized for the application program 122 can be performed without affecting operability in a state where the home screen is displayed.

The storage unit 120 stores the key setting file 128 for setting a function executed by the control unit 140 corresponding to an operation recognized in a state where the home screen is displayed. The control unit 140 executes the function set by the key setting file 128 according to the operation recognized in a state where the home screen is displayed. With this, it is possible to easily set a function in a state where the home screen is displayed.

In a state where the home screen is displayed, in the default mode ST2, when an operation is detected, a function executed by the control unit 140 is set by default. The control unit 140 executes a function selected in advance out of the user mode ST1 set by the key setting file 128 and a function of the default mode ST2. With this, when the execution of the application program 122 ends, a function executed corresponding to an operation can be selected from a default function and a set function.

In the head-mounted display device 100A, the operators in the key operation unit 17 (operating unit) may be defined as a first operator, a second operator, and a third operator, when the first operator is operated, a first operation may be recognized, when the second operator is operated, a second operation may be recognized, and when the third operator is operated, a third operation may be recognized. In this embodiment, an example where the lock button 362 is made the first operation has been shown. In this case, since one operator is allocated for switching among the lock states, it is possible to switch among the lock states by an intuitive operation.

In the head-mounted display device 100A, the key operation unit 17 may include an operator in which a plurality of kinds of operations can be performed. For example, a touch panel may be provided, and the operation recognition unit 184 may distinctively detect a touch (tap) operation, a pinch operation, and a wipe operation on the touch panel. In this case, one of a plurality of kinds of operations on an operator, such as a touch panel, may be allocated to one of the first operation, the second operation, and the third operation. In this case, lock can be set for different kinds of operations on one operator. If the first operation is allocated, it is possible to limit other kinds of operations by a predetermined operation on one operator.

The invention is not limited to the configuration described in the respective embodiments described above, and can be carried out in various forms without departing from the spirit of the invention.

For example, in the foregoing embodiments, although a configuration in which the control devices 10 and 13 include the key operation units 16 and 17 having hardware operators has been illustrated, instead of the key operation units 16 and 17 or in addition to the key operation units 16 and 17, an operating unit using a touch panel may be provided. The operating unit may detect a touch operation on the touch panel as an operation. Furthermore, a display screen may be provided so as to overlap the touch panel, and the position of the touch operation, a function corresponding to the touch operation, or the like may be displayed.

In the first embodiment, although an example where the key code API 123 is called and executed, and a function of displaying the home screen according to an operation of the home button 342 is limited has been described, the invention is not limited thereto. A function which is limited by the key code API 123 is arbitrary, and for example, all functions which interfere with the display of a screen displayed in relation to the application program 122 or visual recognition during the execution of the application program 122 may be limited. Alternatively, when a predetermined condition is established, for example, when the operation of the application program 122 is suspended, the limitation by the key code API 123 may be released. In this case, when the predetermined condition is released, the limitation by the key code API 123 may be resumed.

For example, instead of the image display unit 20, a different type of an image display unit, such as an image display unit which is mounted like a cap, may be employed. Alternatively, a display unit which displays an image corresponding to the left eye of the user and a display unit which displays an image corresponding to the right eye of the user may be provided. Furthermore, the display device according to the invention may be constituted as, for example, a head mounted display which is mounted in a vehicle, such as an automobile or an aircraft. Furthermore, the display device may be constituted as a head mounted display which is embedded in a body protector, such as a helmet. In this case, a portion which determines a position with respect to the body of the user and a portion which is positioned with respect to the portion can be a mounting portion.

In the foregoing embodiments, although a configuration in which the image display unit 20 and the control devices 10 and 13 are separated and connected through the connection unit 40 has been described as an example, a configuration in which the control devices 10 and 13 and the image display unit 20 are constituted integrally, and mounted on the head of the user can be made.

As the control devices 10 and 13, a notebook computer, a tablet computer, or a desktop computer may be used. Furthermore, as the control device 10, a game machine, a mobile phone, a smartphone, a portable electronic apparatus including a portable media player, other dedicated apparatuses, and the like may be used. Furthermore, a configuration in which the control device 10 is separated from the image display unit 20, and various signals are transmitted and received between the control devices 10 and 13 and the image display unit 20 by wireless communication may be made.

For example, as a configuration for generating image light in the image display unit 20, a configuration in which an organic electro-luminescence (EL) display and an organic EL control unit are provided may be made. Furthermore, as a configuration for generating image light, liquid crystal on silicon (LCOS, LCoS is Registered Trademark), a digital micromirror device, or the like may be used.

As an optical system which guides image light to the user's eyes, a configuration in which an optical member configured to transmit external light entering from the outside toward the device is provided, and external light is allowed to enter the user's eyes along with image light. Furthermore, an optical member which is located in front of the user's eyes and overlaps a part or the whole of the visual field of the user may be used. In addition, a scanning type optical system which scans laser light or the like to form image light may be employed. Furthermore, the invention is not limited to a configuration in which image light is guided inside the optical member, and only a function which refracts and/or reflects and guides image light toward the user's eyes may be provided.

For example, the invention can be applied to a laser retina projection type head mounted display. That is, a configuration in which a light emission unit includes a laser light source, and an optical system which guides the laser light source to the user's eyes, laser light enters the user's eyes to scan a retina and is imaged on the retina, thereby allowing the user to visually recognize an image may be employed.

The invention can be applied to a display device which employs a scanning optical system using a MEMS mirror, and uses a MEMS display technology. That is, a signal light forming unit, a scanning optical system which has a MEME mirror configured to scan light emitted from the signal light forming unit, and an optical member on which a virtual image is formed by light scanned by the scanning optical system may be provided as a light emission unit. In this configuration, light emitted from the signal light forming unit is reflected by the MEMS mirror, enters the optical member, is guided in the optical member, and reaches a virtual image forming surface. The MEMS mirror scans light, whereby a virtual image is formed on the virtual image forming surface. The user catches the virtual image with the eyes, whereby an image is recognized. In this case, an optical component may guide light through multiple reflections, for example, like the right light guide plate 261 and the left light guide plate 262 of the foregoing embodiments, or may use a half mirror surface.

An optical element according to the invention is not limited to the right light guide plate 261 and the left light guide plate 262 having half mirrors 261A and 262A, and an optical component which allows image light to enter the user's eyes may be used. Specifically, a diffraction grating, a prism, or a holographic display unit may be used.

At least a part of the functional blocks shown in FIGS. 2 and 5 may be implemented by hardware or may be implemented by cooperation of hardware and software, and the invention is not limited to a configuration in which independent hardware resources are arranged as shown in FIG. 2. Furthermore, a program which is execute by the control unit 140 may be stored in the storage unit 120 or a storage device of the control device 10, or a program stored in an external device may be acquired and executed through the communication unit 117 or the interface 125.

The entire disclosure of Japanese Patent Application Nos. 2014-241189, filed Nov. 28, 2014 and 2015-123465, filed Jun. 19, 2015 are expressly incorporated by reference herein.

What is claimed is:

1. An electronic apparatus which is connected to a head-mounted display device and controls the display of the display device, the electronic apparatus comprising:
an operating unit which receives an operation; and
a control unit which executes a general-purpose operating system and an application program operating on the operating system,
wherein the operating system has a control function which is executed when the operating unit receives a predetermined operation, and includes a program module which is callable by the function of the application program and limits the execution of the control function.

2. The electronic apparatus according to claim 1, further comprising:
a display control unit which controls the display device to display an image,
wherein the control unit allows the display control unit to display a screen for the operating system during the execution of the application program by the control function.

3. The electronic apparatus according to claim 2,
wherein the control unit allows the display of an initial screen of the operating system by the control function.

4. The electronic apparatus according to claim 3,
wherein the initial screen is a screen which is displayed by the display control unit before the application program is executed after the activation of the operating system.

5. The electronic apparatus according to claim 1,
wherein the operating unit includes an operation region or an operator for the control function.

6. The electronic apparatus according to claim 1,
wherein the control unit executes the control function when the operating unit receives a predetermined operation after the application program is stopped during the execution of the operating system.

7. The electronic apparatus according to claim 1,
wherein the operating unit is configured to receive a plurality of operations, and
the control unit is capable of executing a plurality of control functions corresponding to an operation of the operating unit and limits the execution of at least one of the plurality of control functions at the time of the execution of the program module.

8. An electronic apparatus which is connected to a head-mounted display device and controls the display of the display device, the electronic apparatus comprising:
a control unit which executes a general-purpose operating system and an application program operating on the operating system,
wherein the control unit recognizes a first operation, a second operation, and a third operation and executes processing corresponding to a recognized operation, and
the control unit is capable of transiting, corresponding to the first operation, to a full limit state where the second and third operations are disabled, an individual limit state where at least one of the second and third operations is disabled during the execution of the application program, and a limit release state where the second and third operations are respectively recognized.

9. The electronic apparatus according to claim 8, further comprising:
a storage unit which stores disable setting data for setting an operation to disable the individual limited state,
wherein the control unit disables at least one of the second and third operations according to the disable setting data stored in the storage unit in the individual limit state.

10. The electronic apparatus according to claim 9,
wherein the control unit transits to the limit release state when the first operation is recognized in the full limit state or the individual limit state.

11. The electronic apparatus according to claim 10,
wherein the control unit transits to a preset state out of the full limit state and the individual limit state when the first operation is recognized after having transited from the full limit state or the individual limit state to the limit release state.

12. The electronic apparatus according to claim 9,
wherein the control unit transits to a state where the operating system displays a predetermined home screen and the second and third operations are recognizable after the execution of the application program ends.

13. The electronic apparatus according to claim 12,
wherein the storage unit stores home setting data for setting a function executed by the control unit corresponding to an operation recognized in a state where the home screen is displayed, and
the control unit executes a function set by the home setting data when the first operation is recognized in a state where the home screen is displayed.

14. The electronic apparatus according to claim 13,
wherein the control unit executes a function set by the home setting data when one of the second and third operations is recognized in a state where the home screen is displayed.

15. The electronic apparatus according to claim 14,
wherein a function which is executed when the control unit recognizes one of the first, second and third operations in a state where the home screen is displayed is set by default, and
the control unit executes a function selected in advance out of a function set by the home setting data and the function set by default when one of the first, second and third operations is recognized in a state where the home screen is displayed.

16. The electronic apparatus according to claim 8, further comprising:
an operating unit which has a first operator, a second operator, and a third operator,
wherein the control unit recognizes the first operation when the first operator is operated, recognizes the second operation when the second operator is operated, and recognizes the third operation when the third operator is operated.

17. The electronic apparatus according to claim 8, further comprising:
an operating unit which has an operator capable of performing an operation corresponding to each of the second operation and the third operation, and
the control unit recognizes each of the first and second operations to the operator.

18. A method of controlling an electronic apparatus which is connected to a head-mounted display device and controls the display of the display device, the method comprising:
executing a general-purpose operating system and an application program operating on the operating system;
executing a predetermined control function by the operating system when an operating unit receives a predetermined operation; and
controlling the execution of the predetermined control function when a predetermined program module is called by the function of the application program.

19. A method of controlling an electronic apparatus which is connected to a head-mounted display device, recognizes a first operation, a second operation, and a third operation, and controls the display device corresponding to a recognized operation, the method comprising:
executing a general-purpose operating system and an application program operating on the operating system; and
corresponding to the first operation, transiting to a full limit state where the second operation and the third operation are disabled, an individual limit state where at least one of the second and third operations is disabled during the execution of the application program, and a limit release state where the second and third operations are respectively recognized.
